(19) United States
(12) Patent Application Publication
(10) Pub. No.: US 2020/0401503 A1
(43) Pub. Date: Dec. 24, 2020

(54) System and Method for Testing Artificial Intelligence Systems

(71) Applicant: Zeyu GAO, (US)

(72) Inventor: Zeyu GAO, Fremont, CA (US)

(73) Assignee: Zeyu GAO, Fremont, CA (US)

(21) Appl. No.: 16/750,890

(22) Filed: Jan. 23, 2020

Related U.S. Application Data
(60) Provisional application No. 62/865,643, filed on Jun. 24, 2019.

(51) Int. Cl. G06F 11/36

(52) U.S. Cl. CPC G06F 11/3664; G06F 11/3688; G06F 11/3692; G06F 11/3696

(57) ABSTRACT

A method and a system are provided of testing AI applications/systems on a System for testing one or more artificial intelligence System (STAIS) connectable to under-test AI systems (UTAIS) via the AI test connectors/interfaces through AI test platform. The method includes test modeling, data preparation, testing script generation, testing automation, and quality assurance. The system automatically identifies, analyzes, and displays all quality issues of UTAIS.

### RELATED APPLICATIONS

This application claims a benefit of a provisional patent application filed on Jun. 24, 2019 with an application No. 62/865,643.

### BACKGROUND OF THE INVENTION

### 1. Field of the Invention

The present invention belongs to a field of artificial intelligence (AI) testing. More specifically the present invention belongs to a field involving AI system/software testing method and system.

### 2. Description of the Related Art

A related topic for AI Software testing is AI-based software testing. AI-based software testing refers to the applications of AI methods and solutions to automatically optimize a software test process in test strategy selection, test generation, test selection and execution, bug detection and analysis, and quality prediction. In the recent years, there are numerous research papers addressing this subject in different areas. They could be useful in facilitating AI software testing and automation.

However, the sufficiency and versatility of AI systems are based on the accuracy of test data set. It is difficult to provide supports due to the accessibility of test data quality issue. The current AI systems has various vulnerabilities and system analysis and defect detection are extremely difficult. Unlike traditional software systems, AI applications do not have a clear controllable logic and understandability since the process to make decision rely on the training data. News have been broadcasting about the accidents caused by unexpected unforeseen driving conditions in smart vehicles. The reason behind these consequences are due to lacking a systematic way of adequate testing in AI systems.

### BRIEF SUMMARY OF THE PRESENT INVENTION

The present invention proposes methods and systems for testing AI system(s), i.e., for testing under-test AI systems (UTAIS).

The presently invented methods include steps as follows:
1. AI software/system requirement analysis;
2. AI function test modeling of a spanning tree to be represented by a multi-dimension AI function classification decision table;
3. An application including input data preparation, testing script generation, testing automation, and quality assurance.

The presently invented systems include a framework, a service platform, a resource library, and an automation solution. The AI system and AI Function are able to test under this presently is descripted in FIG. 35 and FIG. 36.

### BRIEF DESCRIPTION OF THE DRAWINGS

FIG. 1 illustrates that a System for testing one or more artificial intelligence System (STAIS) (100) includes an AI test framework (101), an AI test platform (102), an AI test resource library (103), and an AI-based AI test solution (104).

FIG. 2 illustrates that the AI test framework (101) includes an AI test analysis and modeling process (201), an AI test quality evaluation process (202), an AI test connectors/interfaces process (203), and an AI test generation & scripting process (204).

FIG. 3 illustrates that an AI test platform (102) supports at least five sub-platforms, including a medical system sub-platform (301), a business intelligence sub-platform (302), an unmanned vehicle sub-platform (303), an AI mobile app sub-platform (304), and a smart robotic sub-platform (305).

FIG. 4 illustrates that an AI test resource library (103) contains the classified libraries including background image (401), background audio (402), image (403), audio (404), video (405), text/string (406), data augmentation (407), and data model (408).

FIG. 5 illustrates that an AI-based AI test solution (104) is the process of STAIS for different AI engines, including an AI-based test modeling engine (501), an AI-based test case engine (502), an AI-based test scripting engine (503), an AI-based debugging engine (504), and an AI-based test data recommendation engine (505).

FIG. 6 is a flow diagram of a process of classification-based test automation for the STAIS.

FIG. 7 is a flow diagram of a process of classification-based re-test automation for the STAIS.

FIG. 8 is a flow diagram of a process of classification-based automation for the STAIS.

FIG. 9 is a block diagram of an example of spanning tree of a bill reader AI application.

FIG. 10 is a block diagram of a content classification of spanning tree (901) from previous example in FIG. 9.

FIG. 11 is a block diagram of a bill state of spanning tree (902) from previous example in FIG. 9.

FIG. 12 is a block diagram of a bill classification of spanning tree (903) from previous example in FIG. 9.

FIG. 13 is a block diagram of an AI output of spanning tree (904) from previous example in FIG. 9.

FIG. 14 is a block diagram of an example of multi-dimension decision table (1401, 1402, and 1403) of a word reader AI application.

FIG. 15 illustrates that an approach of white-box testing for 4 different areas.

FIG. 16 is a flow diagram of a general process of white-box testing.

FIG. 17 is a block diagram of a testing coverages of AI white-box testing quality evaluation.

FIG. 18 is a block diagram of various services on the AI test platform.

FIG. 19 is a block diagram of an example of AI test service platforms—cloud-based intelligent medical test platform.

FIG. 20 is a block diagram of various operations/functions of AI medical application testing scope.

FIG. 21 is a block diagram of various operations/functions of AI business application testing scope.

FIG. 22 is a block diagram of an example of AI test service platforms—cloud-based intelligent drone test platform.

FIG. 23 is a block diagram of various operations/functions of drone testing scope.

FIG. 24 is a block diagram of an example of AI test service platforms—cloud-based intelligent unman vehicle test platform.

FIG. 25 is a block diagram of various operations/functions of unman vehicle testing scope.

FIG. 26 is a block diagram of an example of AI test service platforms—cloud-based intelligent robot test platform.

FIG. 27 is a block diagram of various operations/functions of robot testing scope.

FIG. 28 is a flow diagram of a process of AI-based test modeling engine (2801) in the STAIS.

FIG. 30 is a flow diagram of a process of AI-based test case engine (2901) in the STAIS.

FIG. 29 is a flow diagram of a process of AI-based test scripting engine (3001) in the STAIS.

FIG. 31 is a flow diagram of a process of AI-based debugging engine (3101) in the STAIS.

FIG. 32 is a flow diagram of a process of AI-based test data recommendation engine (3201) in the STAIS.

FIG. 33 illustrates that a process of AI testing with test script generator (3501) and test runner (3502).

FIG. 34 illustrates that a conversion between test scenario template (3401) and test scenario (3402).

FIG. 35 illustrates that the testing scopes of AI systems.

FIG. 36 illustrates that the testing scopes of AI functions.

FIG. 37 is a block diagram of an example of spanning tree of a bill reader AI application.

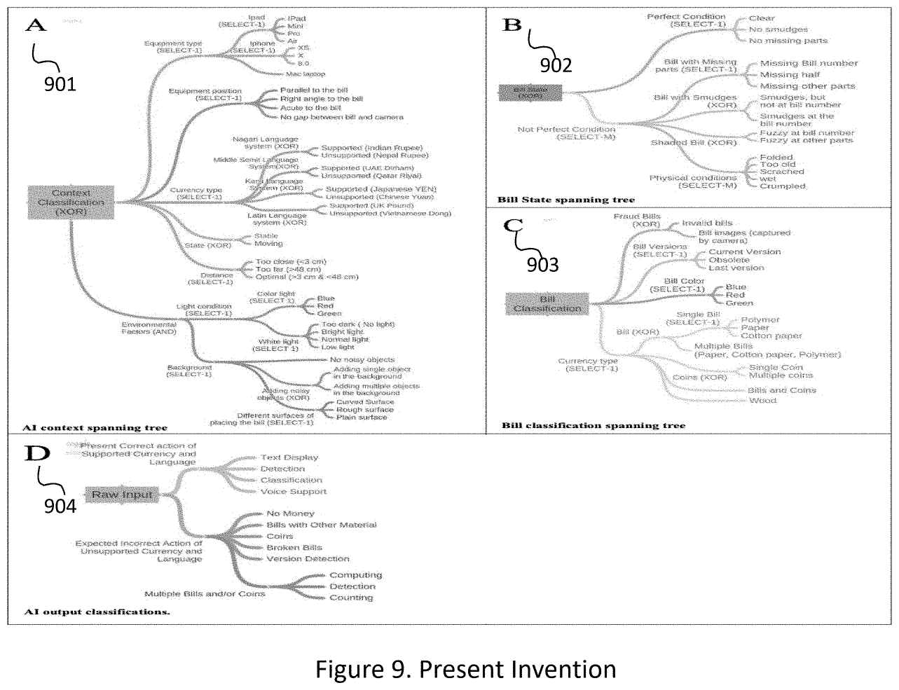

FIG. 38 is a block diagram of a content classification of spanning tree (901) from previous example in FIG. 9.

FIG. 39 is a block diagram of a bill state of spanning tree (902) from previous example in FIG. 9.

FIG. 40 is a block diagram of a bill classification of spanning tree (903) from previous example in FIG. 9.

FIG. 41 is a block diagram of an AI output of spanning tree (904) from previous example in FIG. 9.

FIG. 42 is a block diagram of an example of multi-dimension decision table (1401&1402&1403) of a word reader AI application.

FIG. 43 illustrates that the approaches of white-box testing for UTAIS.

FIG. 44 is a flow diagram of an evaluation process of white-box testing.

FIG. 45 is a flow diagram of the general steps of AI test service Platform, and connection between each member/group in the AI test service platform network.

FIG. 46 illustrates that AI function features of AI system/software, and how STAIS transfers input raw data to output.

FIG. 47 is a flow diagram of a quality validation process of AI function/system quality assessment.

FIG. 48 illustrates system parameters of UTAIS tested by STAIS.

FIG. 49 illustrates function parameters of UTAIS tested by STAIS.

### DETAILED DESCRIPTION OF THE INVENTION

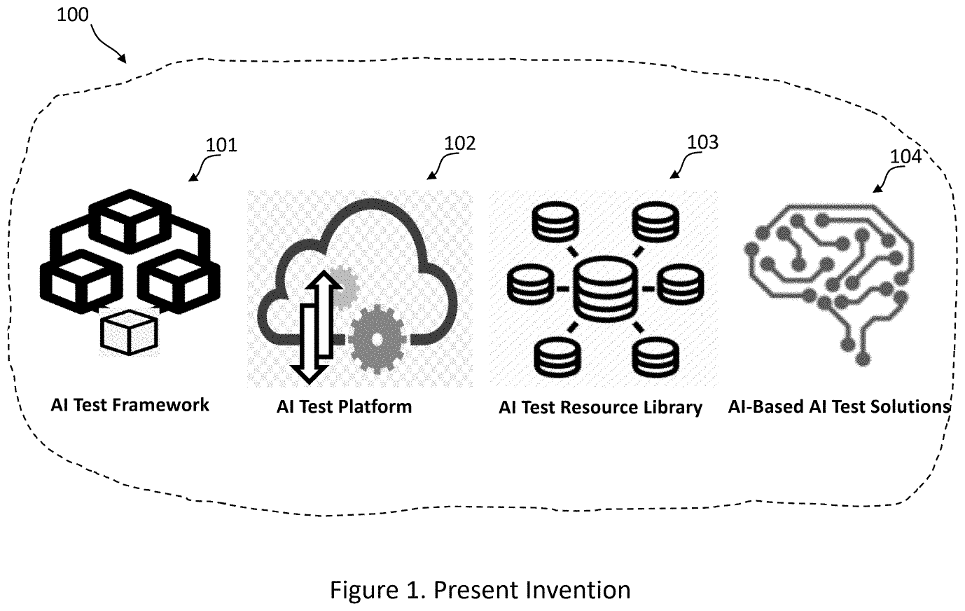

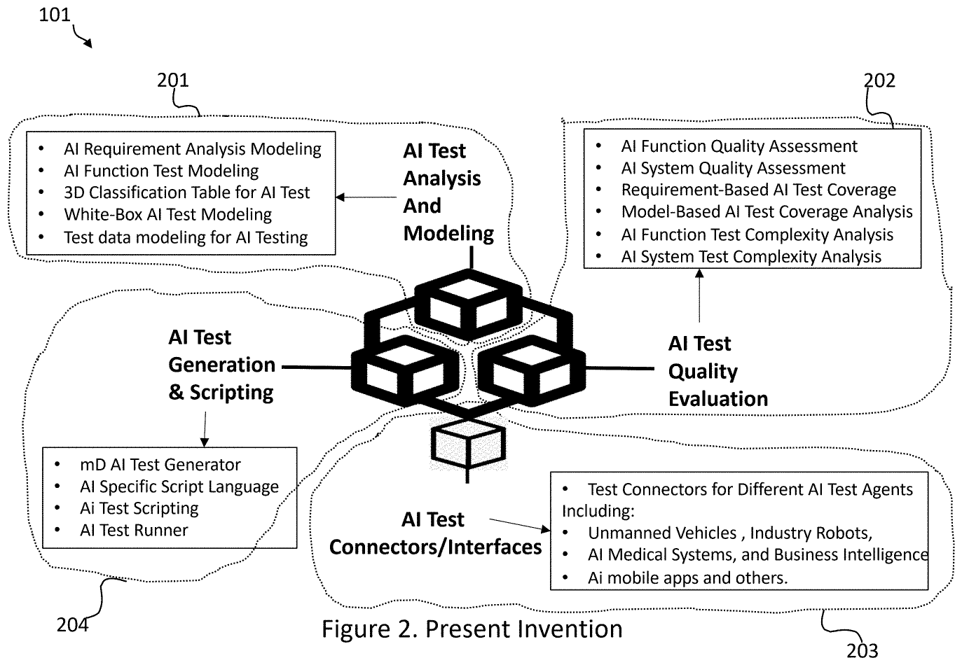

FIG. 1 illustrates that a System for testing one or more artificial intelligence System (STAIS) (100) has four complements, including an AI test framework (101), an AI test service platform (102), an AI test resource library (103), and an AI-based AI test solution (104).
a. The AI test framework (101) includes AI test analysis and modeling process (201), AI test quality evaluation process (202), AI test connectors/interfaces process (203), and AI test generation & scripting process (204).
b. The AI test service platform (102) is a service platform supports at least five sub-platforms, including a medical system sub-platform (301), a business intelligence sub-platform (302), an unmanned vehicle sub-platform (303), an AI mobile app sub-platform (304), and a smart robotic sub-platform (305).
c. AI test resource library (103) includes eight classified AI testing model libraries, there are a classified background image library (401), a classified background audio library (402), a classified image library (human, animal, and objects) (403), a classified audio library (human, cars, animals, . . . ) (404), a classified video library, classified text/string library (405), a classified data augmentation model library (406), and a classified data model library (407).
d. AI-based AI test solution (104) includes five AI-based engines, there are an AI-based test modeling engine (501), an AI-based test case engine (502), an AI-based test scripting engine (503), an AI-based debugging engine (504), and an AI-based test data recommendation engine (505).

FIG. 2 illustrates that an AI test framework (101) includes an AI test analysis and modeling process (201), an AI test quality evaluation process (202), an AI test connectors/interfaces process (203), and an AI test generation & scripting process (204).
a. The AI test analysis and modeling process (201) performs different types of modeling, including AI function test modeling, multi-dimension classification table (black-box testing) and white-box AI test modeling, and test data modeling.
b. The AI test quality evaluation process (202) determines the quality of AI functions and systems, test coverage of requirement-based AI and modeling-based AI, and complexity analysis of AI function test and AI system test.
c. The AI test connectors/interfaces process (203) is the connection interfaces between the STAIS and the UTAIS and supporting test automation and services for UTAIS. The UTAIS include unmanned vehicles, industry robots, AI medical system, business intelligence, and AI mobile apps.
d. The AI test generation & scripting process (204) includes md AI test generator, AI specific script language, AI test scripting, and AI test runner. the purpose of AI test generation & scripting is to automatically generate md AI function classification test models, test frames, test cases, test data, and test scripts based on pre-selected language and platforms. using AI test runner, AI system automatically control and monitor the test operations of selected test scripts on multiples selected test platforms in parallel or sequential operation modes.

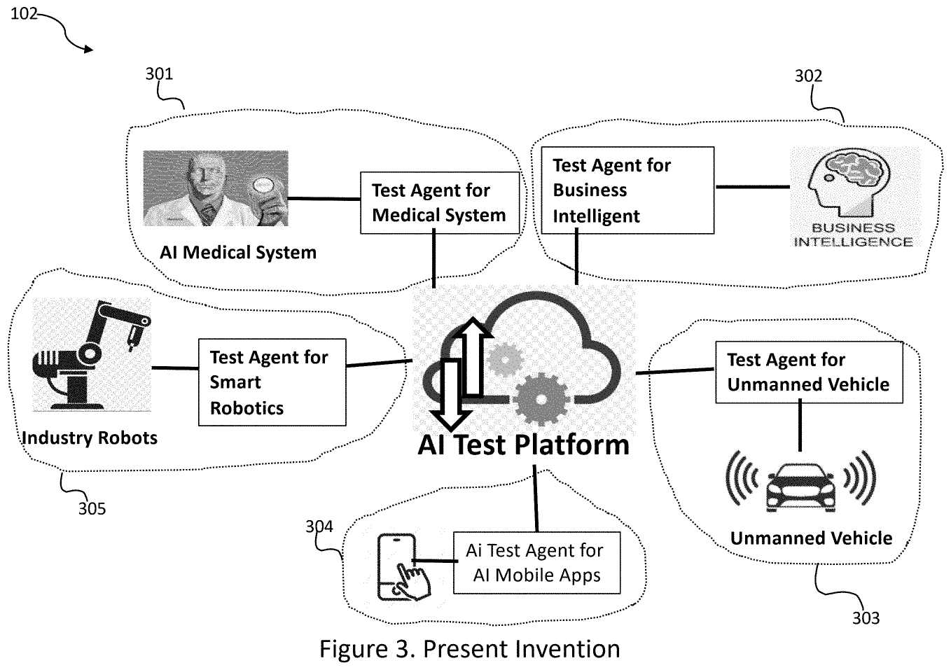

FIG. 3 illustrates that an AI test service platform (102) stands for test agent (platforms) which can run AI test for different groups. There are two different deploy models for services:
a. Enterprise-oriented deploy model for enterprise users only
b. Crowed-sourced service deploy model for public users.

FIG. 3 illustrates that the AI test service platform supports at least five sub-platforms, including a medical system sub-platform (301), a business intelligence sub-platform (302), an unmanned vehicle sub-platform (303), an AI mobile app sub-platform (304), and a smart robotic sub-platform (305).

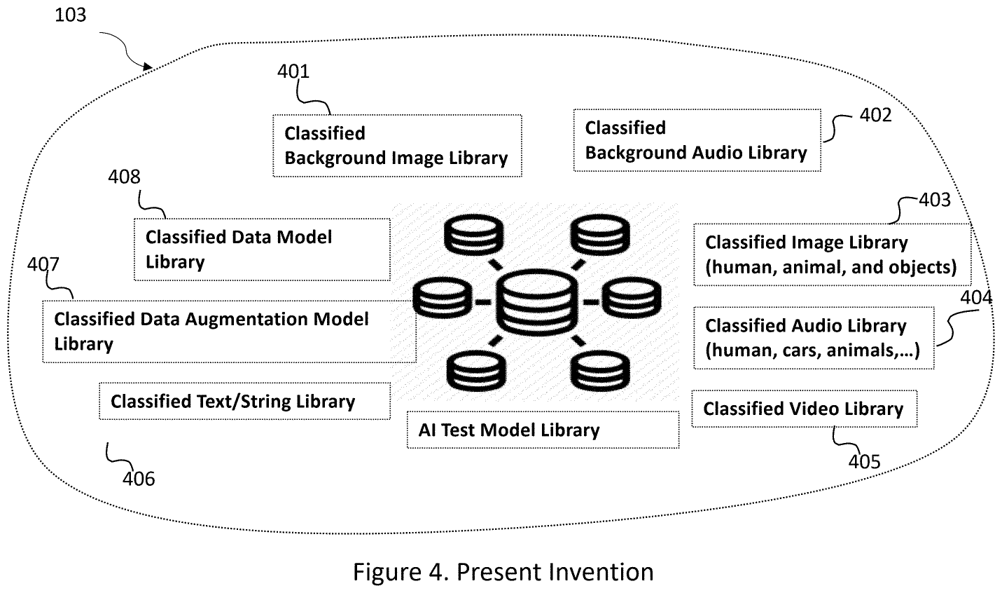

FIG. 4 illustrates that an AI test resource library (103) includes many classified resource libraries from previous testing experience. The STAIS uses the standard built-in classifications from AI test resource library for different types of test data, test models, and different test commands. There are 7 different classified libraries.
a. A classified background image library (401): classify background image, transfer data and store into background image library.
b. A classified background audio library (402): classify background audio, transfer data and store into background audio library.
c. A classified object image library (human, animal, and objects) (403): classify object image, transfer data and store into object image library.
d. A classified object audio library (human, cars, animals, . . . ) (404): classify object audio, transfer data and store into object audio library.
e. A classified object video library (405): classify object video, transfer data and store into object video library.
f. A classified text/string library (406): classify text and string, transfer data and store into text/string library.
g. A classified data augmentation model library (407): create multiple objects (different orientations, sizes, lightness) with a given object and store into data augmentation model library.
h. A classified data model library (408): store the data model.

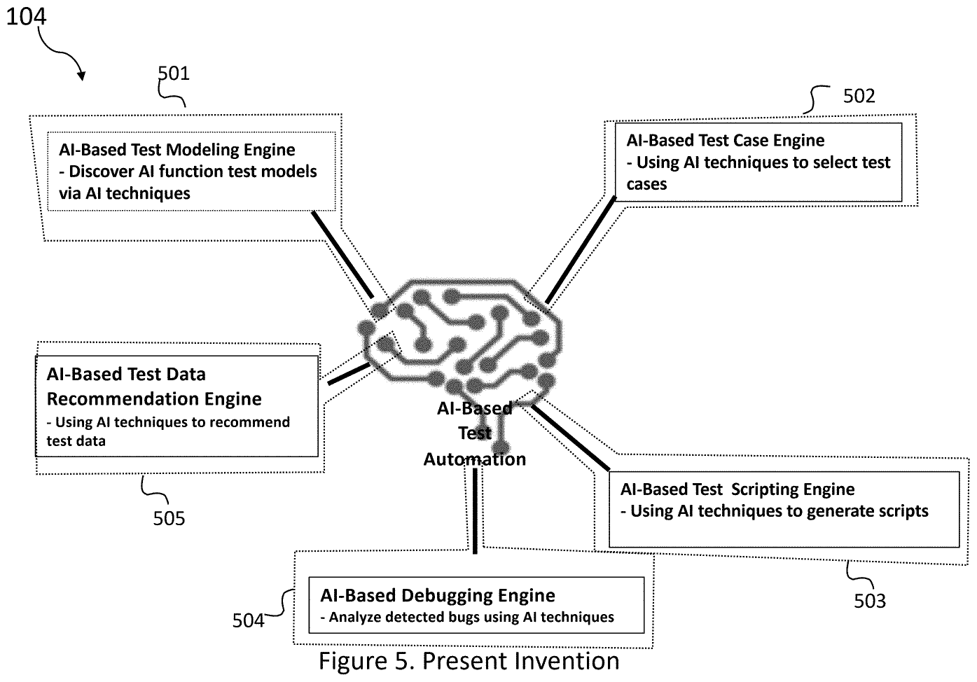

FIG. 5 illustrates that an AI-based AI test solution (104) is the solution which generates from the STAIS. The STAIS selects current test cases corresponding to different AI systems or AI applications. then STAIS starts to create scripts and models for testing systems or applications, and analysis bugs. after that, STAIS checks the quality of AI systems or AI applications, then do evaluation and validation for the result.
a. An AI-based test modeling engine (501): automatically discovering test models based on existing AI test models and assisting derivation of new AI test model.
b. An AI-based test scripting engine (502): automatically assisting on generation and derivation of new test scripting.
c. An AI-based test selection engine (503): automatically selecting most frequency test cases on test cases history and testing all selected test cases.
d. An AI-based bug engine (504): automatically analyzing and detecting bug with selected test cases and generating the detailed information of bugs.
e. An AI-based test data recommendation engine (505): automatically finding most effective data with given test model and test script.

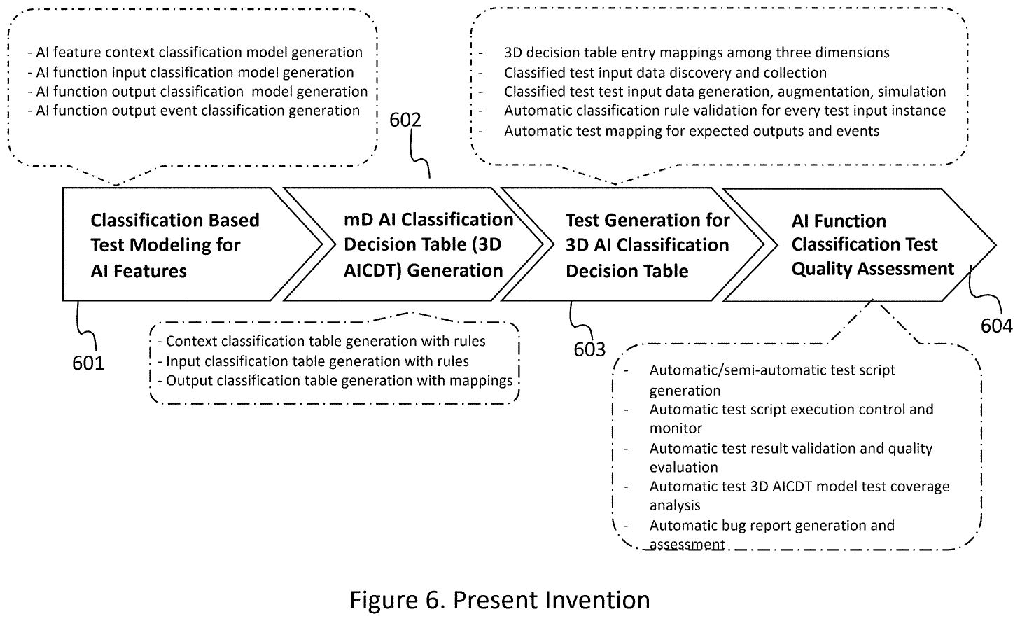

FIG. 6 is a flow diagram of a classification-based test automation for AI function is the general steps of test automation. on the first step, a classification-based test modeling for AI feature (601), it automatically generates the classified test model for context, input, and output. on the second step, a multi-dimension AI classification decision table generation (602) generates the classification table with rules for context, input, and output. on the third step, a test generation for multi-dimension AI classification decision table (603) automatically collects all test data and classifies test input data generation, augmentation, and simulation, then automatically validates all test input data and map for expected outputs and events. on the forth step, an AI function classification test quality assessment (604), it automatically generates the quality assessment which includes test script, test result validation and quality evaluation, test converge analysis, and bug report and assessment.

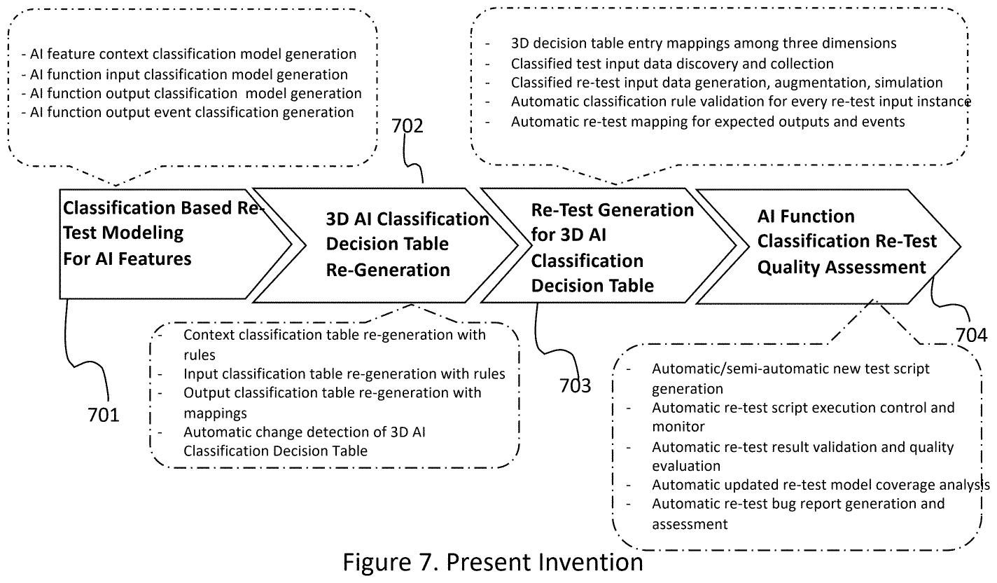

FIG. 7 is a flow diagram of a classification-based re-test automation for AI function is the general steps of re-test automation. on the first step, a classification-based test modeling for AI feature (701), it automatically re-generates the classified test model for context, input, and output. on the second step, a multi-dimension AI classification decision table generation (702) automatically re-generates the classification table with rules for context, input, and output. on the third step, a test generation for AI classification decision table (703) automatically re-collects all test data and re-classifies test input data generation, augmentation, and simulation, then re-validates all test input data and re-map for expected outputs and events. on the forth step, an AI function classification test quality assessment (704) automatically re-generates the quality assessment which includes re-tested test script, re-tested test result validation and quality evaluation, re-tested test converge analysis, and re-tested bug report and assessment.

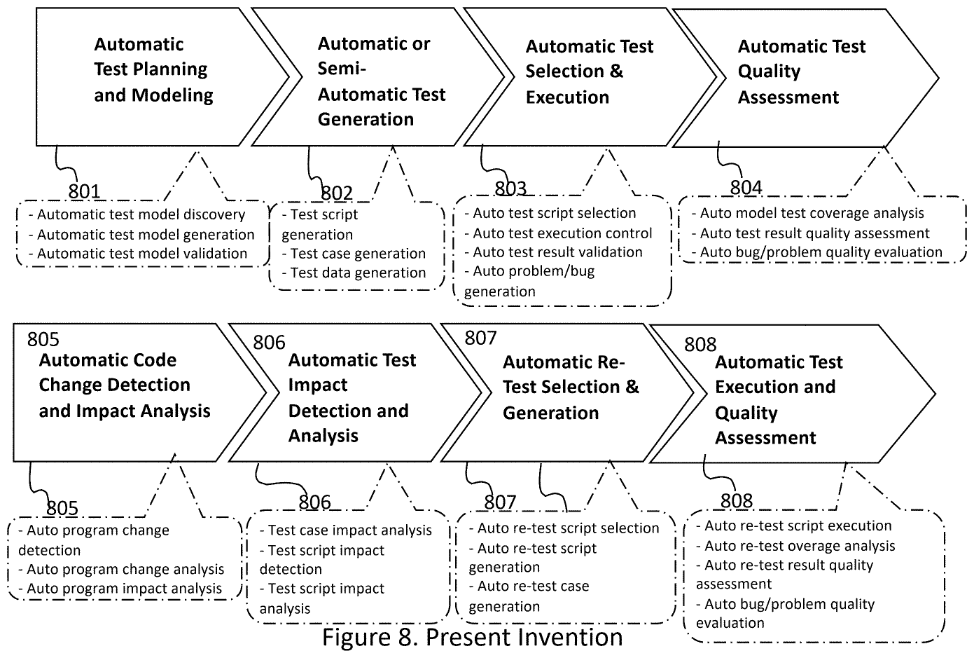

FIG. 8 is a flow diagram of a classification-based test automation process for the STAIS.
a. An automatic test planning and modeling process (801): automatically discovery test model and general test model.
b. An automatic or semi-automatic test generation process (802): automatically general test script, test case, and test data.
c. An automatic test selection & execution process (803): automatically select test script, control test execution, validate test result, and general problem/bug.
d. An automatic test quality assessment process (804): automatically analysis test model coverage and problem/bug quality.
e. An automatic code change detection and impact analysis process (805): automatically detect and analysis for program change and impact.
f. An automatic test impact detection and analysis process (806): automatically analysis test case impact, and analysis & detect test script impact.
g. An automatic re-test selection & generation process (807): automatically select, and general re-test script and general re-test cases.
h. An automatic test execution and quality assessment process (808): execute re-test script, analysis re-test converge, validate re-test result quality, and evaluate bug/problem quality.

FIG. 9 is a block of tree diagrams of spanning trees from an AI application (bill reader). The STAIS automatically creates a multi-dimension decision table based on the AI context spanning tree (901), state spanning tree (902), and classification spanning tree (903), then generates the result spanning tree—AI output classification spanning tree (904). (Black-Box Testing)

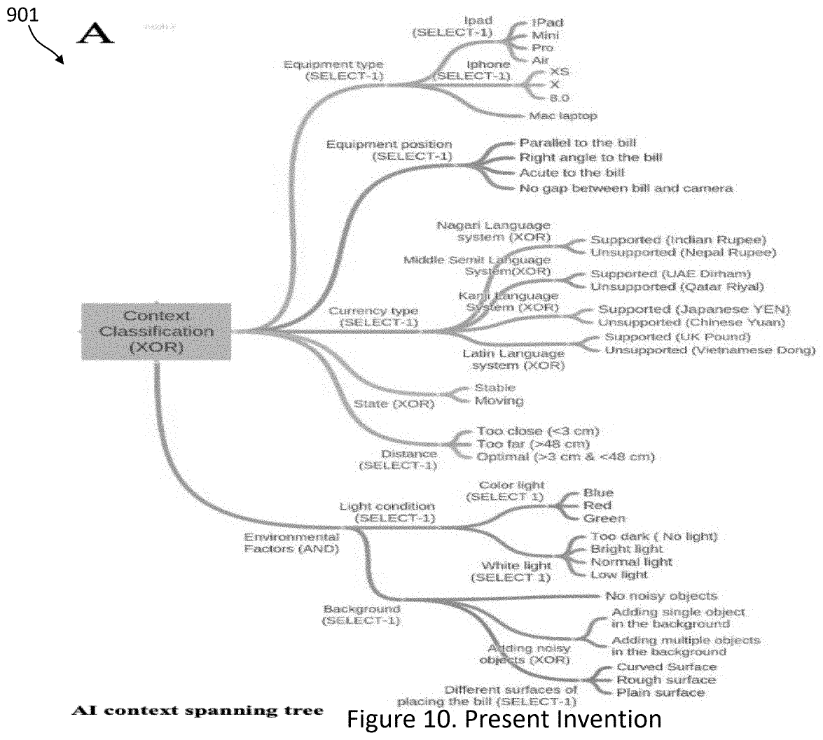

FIG. 10 is a tree diagram of a context classification of spanning tree (901), its leaves automatically generate based on the context of UTAIS.

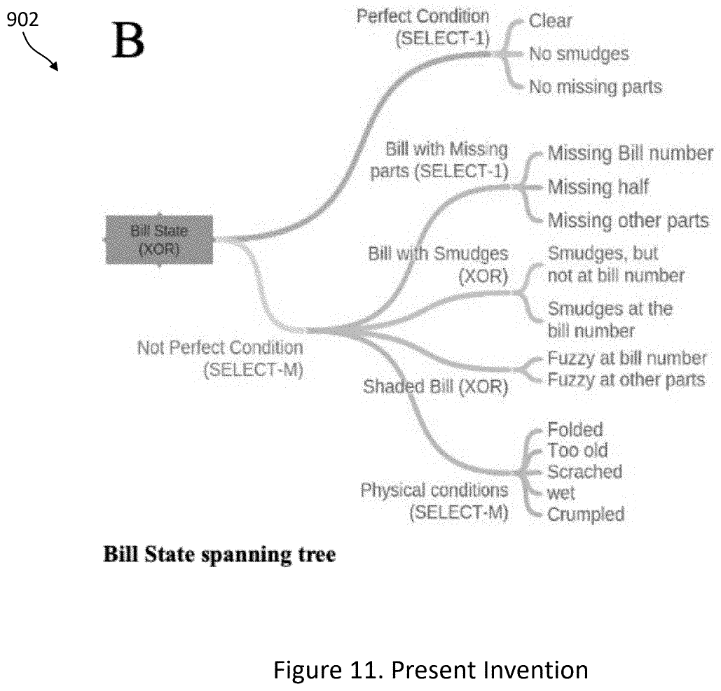

FIG. 11 is a tree diagram of a bill state spanning tree (902), its leaves automatically generate based on the context of UTAIS.

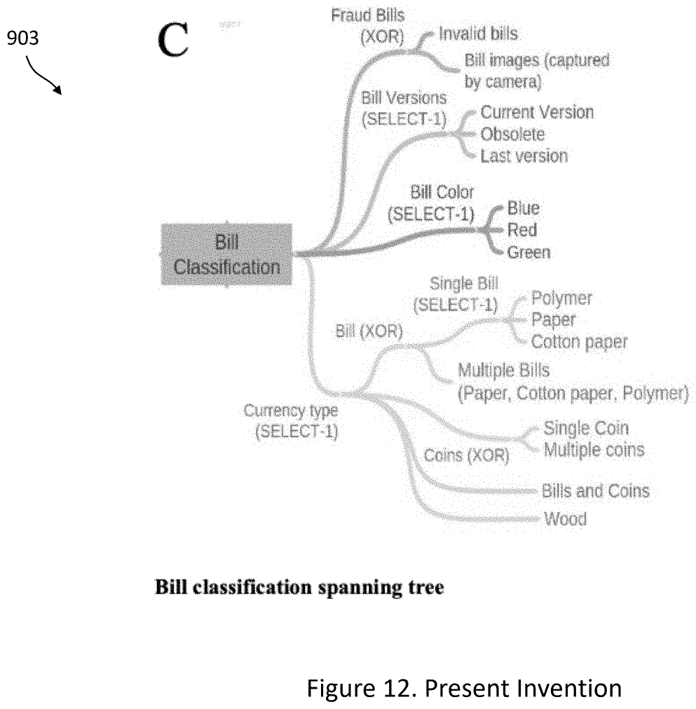

FIG. 12 is a tree diagram of a bill classification spanning tree (903), its leaves automatically generate based on the context of UTAIS.

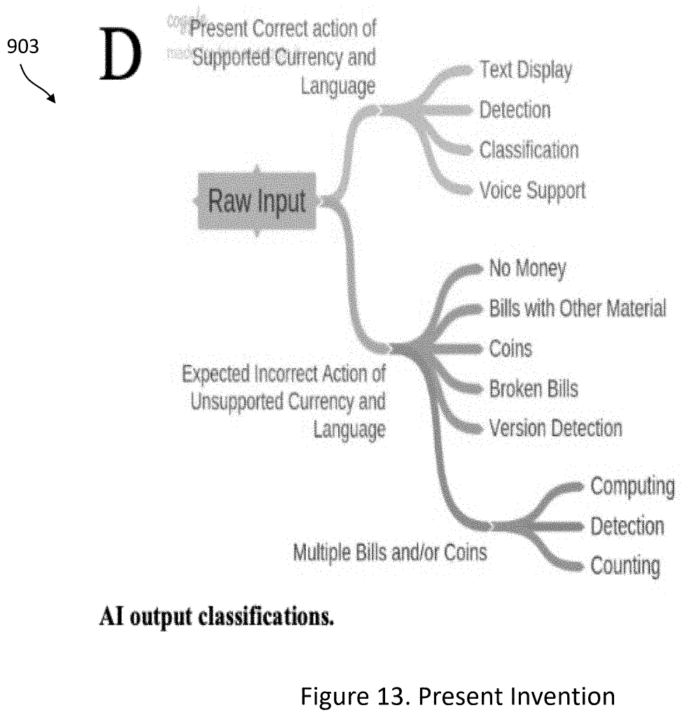

FIG. 13 is a tree diagram of an output of spanning tree (904), its leaves automatically generate based on the context of UTAIS.

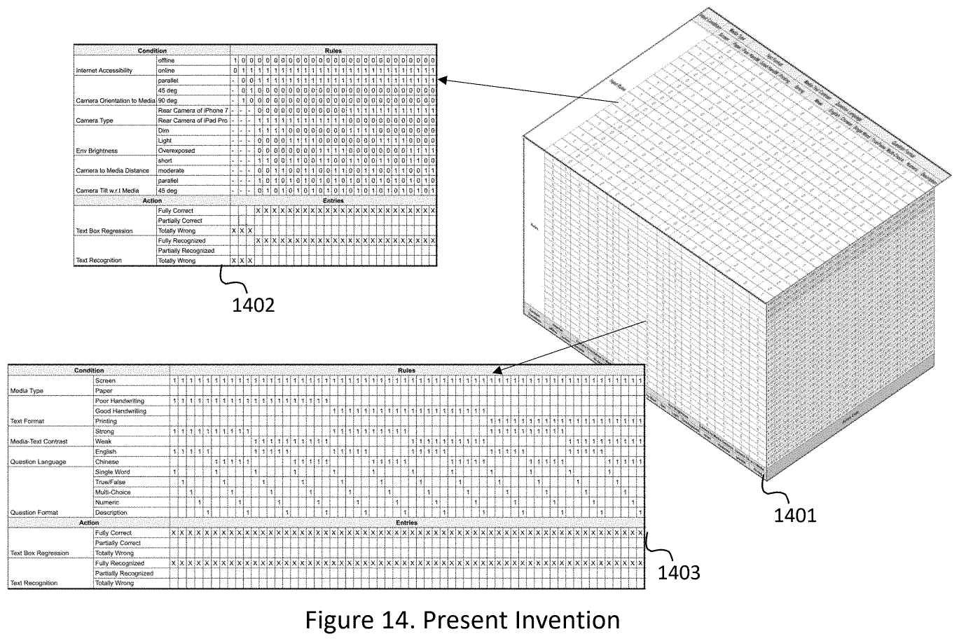

FIG. 14 is a block diagram of a multi-dimension decision table (1401) from UTAIS (word reader). Top surface has the same information of the context spanning tree (1402), and front surface has the classification spanning tree and the state spanning tree (1403), the right surface is the AI output classification spanning tree and all decisions on the AI output classification spanning tree which is determined by different combination of the context spanning tree (901), the state spanning tree (902), and the classification spanning tree (903). The number of dimensions depends on the amount of conditions and context. (Black-Box Testing)

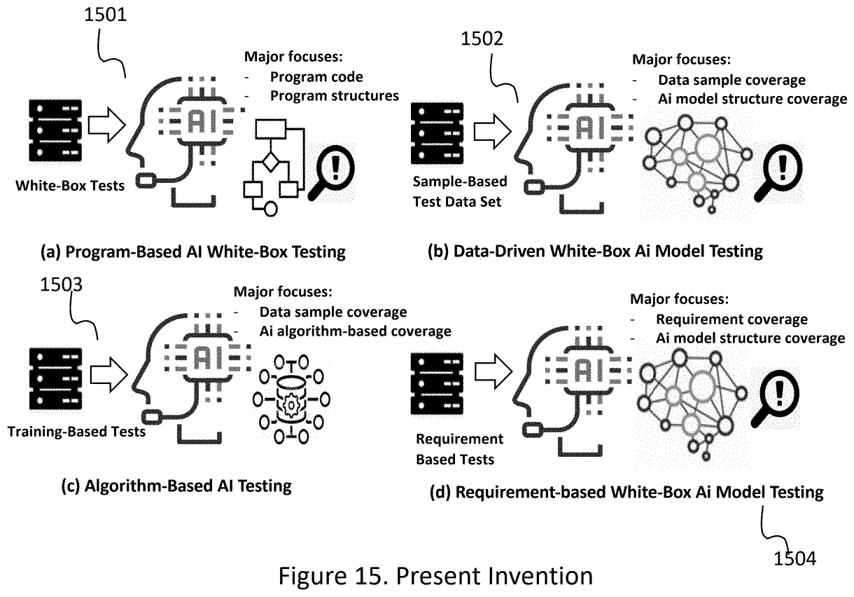

FIG. 15 illustrates that white-box testing for STAIS includes four testing ways to test UTAIS under white-box testing.
A. A program-based AI white-box testing process (1501): this part of testing majorly focuses on program code and program structures for testing AI-based application.
B. A data-driven white-box AI model testing process (1502): this part of testing majorly focuses on data sample coverage and AI model structure coverage for testing AI-based application.
C. An algorithm-based AI testing process (1503): this part of testing majorly focuses on data sample coverage and AI algorithm-based coverage for testing AI-based application.
D. A requirement-based white-box AI model testing process (1504): this part of testing majorly focuses on requirement coverage and AI model structure coverage for testing AI-based application.

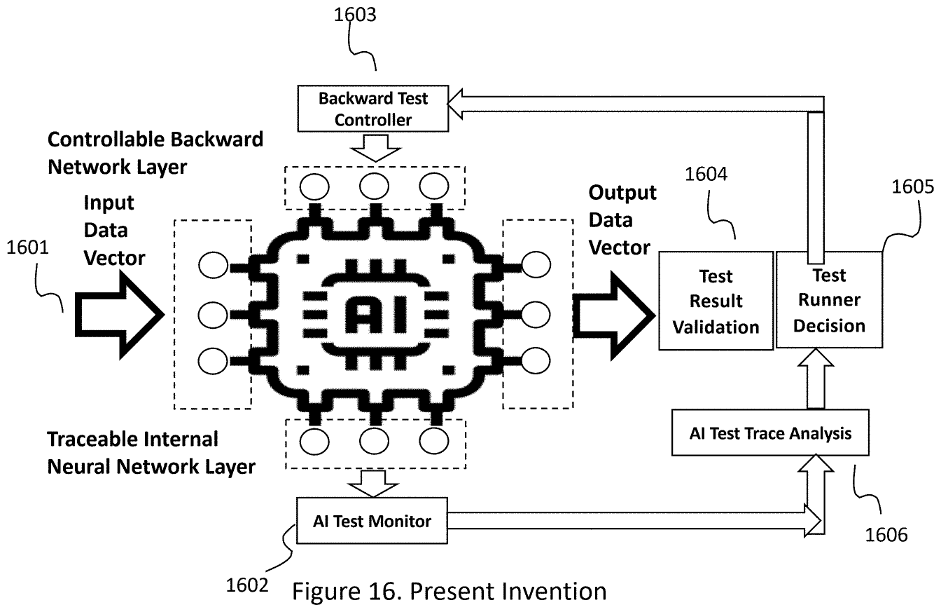

FIG. 16 illustrates that a process of white-box testing for AI applications. first, the STAIS automatically inputs all raw data vector into traceable internal neural network layer (1601). during the process of testing, an AI test trace analysis (1606) generates and displays from AI test monitor (1602). at the same time, output data will be generated and validate with expected output data. finally, test runner determines whether test result is validated or not based on test result validation (1604) and AI test trace analysis (1606). if the output data vector does not pass the test runner decision (1605), it will re-test through backward test controller (1603) until the output data passes test runner decision (1605).

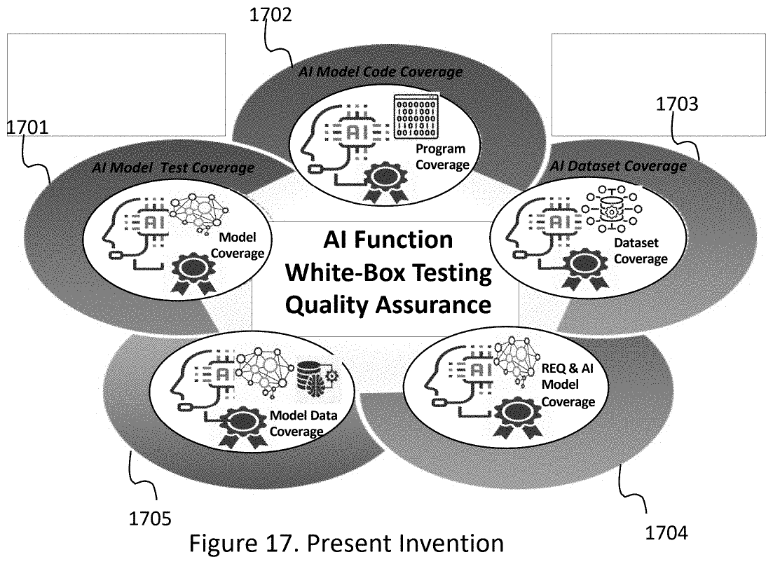

FIG. 17 is a flow diagram of an AI white-box testing quality evaluation process. In order to have the assurance of AI function white-box testing quality, the AI white-box testing has five coverages to determine.
a. An AI model test coverage process (1701): majorly focus on AI test model and determine the coverage of model.
b. An AI model code coverage process (1702): majorly focus on AI program code and determine the coverage of program.
c. An AI dataset coverage process (1703): majorly focus on AI dataset and determine the coverage of dataset.
d. A Req & AI model coverage process (1704): majorly focus on AI requirement-based model and determine the coverage of requirement-based model.
e. A model data coverage process (1705): majorly focus on AI model data and determine the coverage of model data.

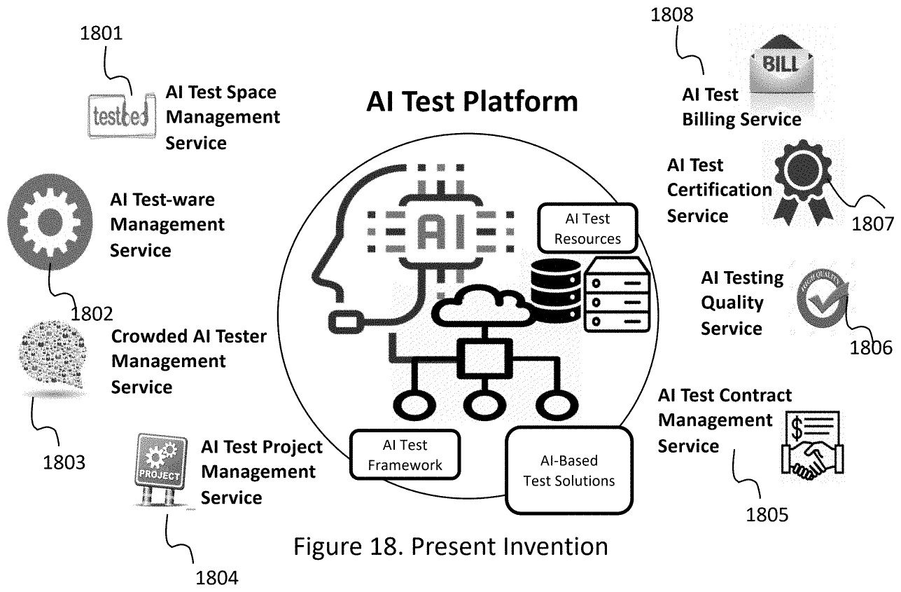

FIG. 18 illustrates that an AI test platform includes two parts. The core part has the AI test framework, the AI-based test solutions, and the AI test resources. And eight service parts assist the core part of the AI test platform.
a. An AI test space management service (1801): platform performs visual testing lab/infrastructure (testing requirements) for AI application.
b. An AI test-ware management service (1802): platform supports AI testing solutions and tools.
c. crowded AI tester management service (1803): efficiently testing with AI applications.
d. An AI test project management service (1804): user-friendly manage project and check the testing process on our AI test platform.
e. An AI test contract management service (1805): generate the contract with the AI application which should be tested on our platform.
f. An AI testing quality service (1806): analysis the quality of testing for applications.
g. An AI test certification service (1807): generate the certification after an AI application is satisfied with all testing requirements
h. An AI test billing service (1808): generate the budget of testing on our AI test platform.

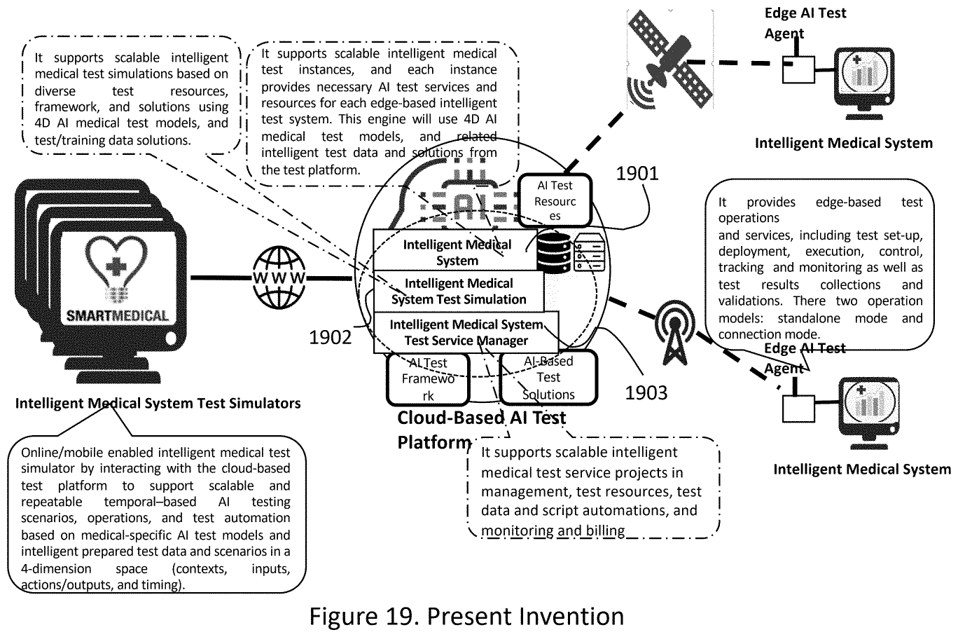

FIG. 19 illustrates that a cloud-based intelligent medical test platform indicates that how intelligent medical application interfaces with cloud-based AI test platform. The AI test service platform supports and tests on simulations based on diverse test resources, framework, and solutions using AI medical test models and test data solutions. Inside of could-based AI test platform, there are 3 core parts to support system.
a. An intelligent medical system (1901): it supports scalable intelligent medical test instances, and each instance provides necessary AI test services and resources for each edge-based intelligent test system. this engine will use 4d AI medical test models, and related intelligent test data and solutions from the test platform.
b. An intelligent medical system test simulation (1902): it supports scalable intelligent medical test simulations based on diverse test resources, framework, and solutions using 4d AI medical test models, and test/training data solutions.
c. An intelligent medical system service manager (1903): it supports scalable intelligent medical test service projects in management, test resources, test data and script automations, and monitoring and billing

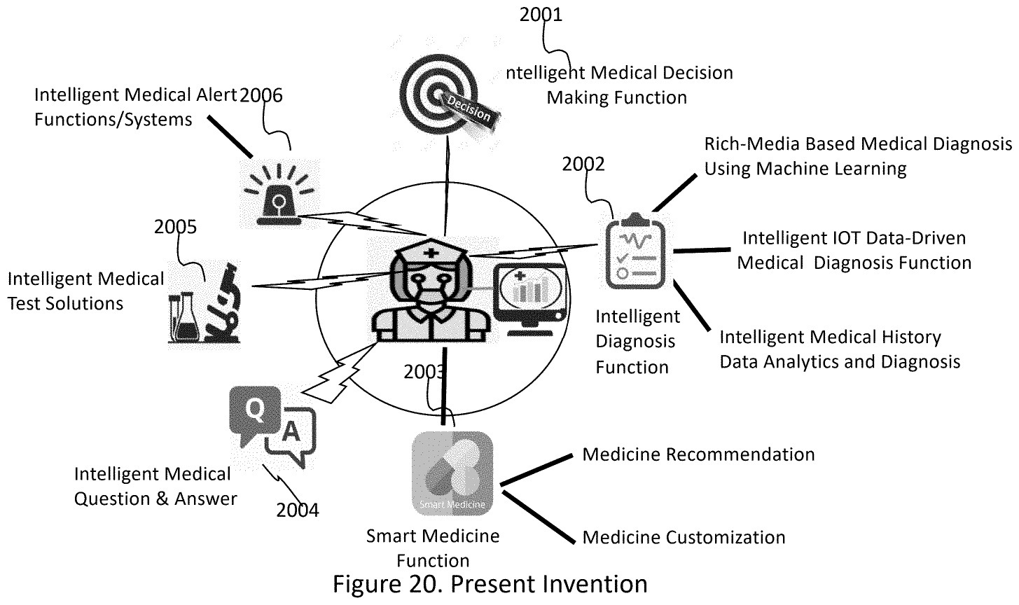

FIG. 20 illustrates that a testing scope of general intelligent medical system. a general intelligent medical system has intelligent medical alert function/systems (2006), intelligent medical test solutions (2005), intelligent medical question & answer (2004), smart medicine function (2003) (medicine recommendation and medicine customization), intelligent diagnosis function (2002), and intelligent medical decision-making function (2001). the cloud-based intelligent medical test platform tests all of those complements and demonstrate the quality and service for each part.

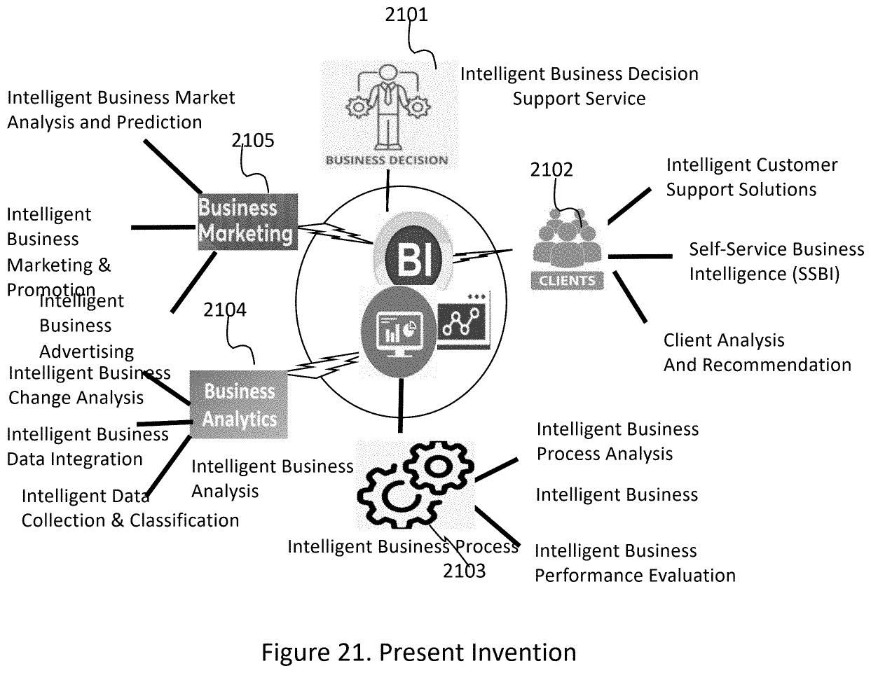

FIG. 21 illustrates that a testing scope of general intelligent business system. a general intelligent medical system has business marketing (2105), business analytics (2104), intelligent business process (2103), intelligent service for clients (2102), and intelligent business decision support service (2101). the cloud-based intelligent business test platform tests all of those complements and demonstrate the quality and service for each part.

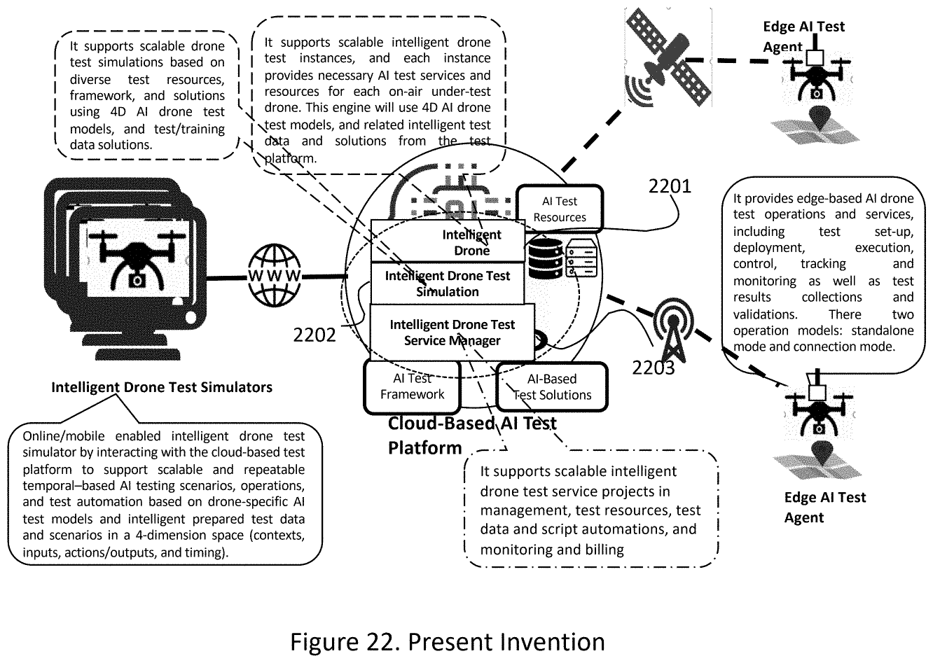

FIG. 22 illustrates that a cloud-based intelligent drone test platform indicates that how intelligent drone interfaces with cloud-based AI test platform. The AI test service platforms will support and test on simulations based on diverse test resources, framework, and solutions using 4d AI drone test models and test data solutions. Inside of could-based AI test platform, there are 3 core parts to support system.
a. An intelligent drone system (2201): it supports scalable intelligent drone test instances, and each instance provides necessary AI test services and resources for each on-air under-test drone. This engine will use 4d AI drone test models, and related intelligent test data and solutions from the test platform.
b. An intelligent drone system test simulation (2202): it supports scalable drone test simulations based on diverse test resources, framework, and solutions using 4d AI drone test models, and test/training data solutions.
c. An intelligent drone service manager (2203): it supports scalable intelligent drone test service projects in management, test resources, test data and script automations, and monitoring and billing.

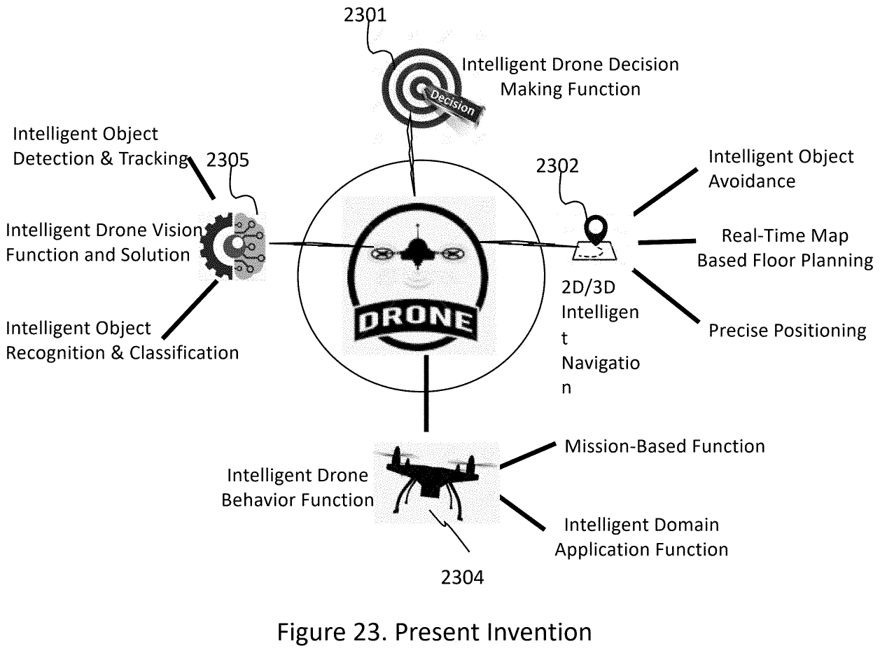

FIG. 23 illustrates that a testing scope of general intelligent drone. a general intelligent drone has intelligent object detection & tracking, intelligent drone vision function and solution, intelligent object recognition & classification (2305), intelligent drone behavior function (2304) (mission-based function and intelligent domain application function), 2d/3d intelligent navigation (2302), and intelligent drone decision making function (2301). the cloud-based intelligent drone test platform testes all of those complements based on timeline and demonstrate the quality and service for each part.

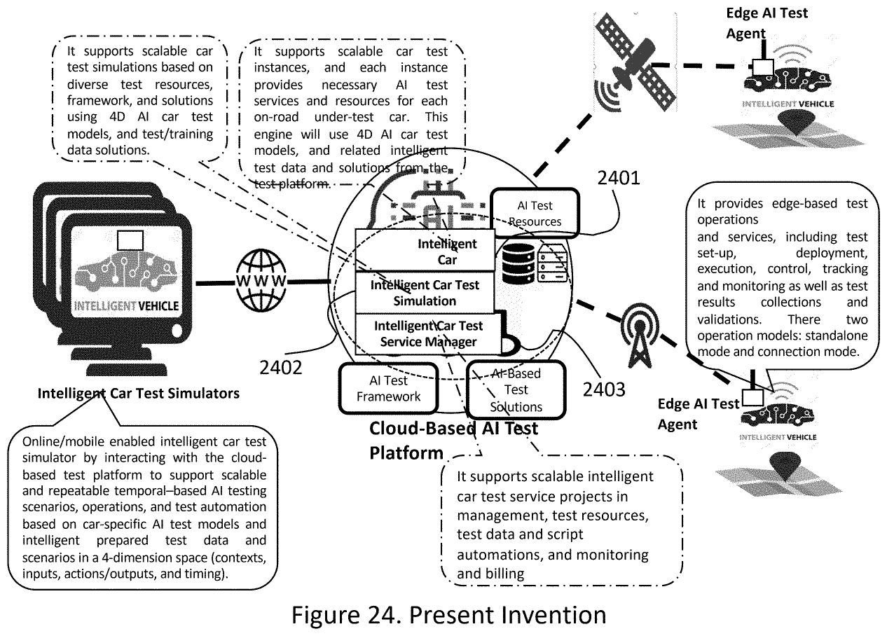

FIG. 24 illustrates that a cloud-based intelligent unman vehicle test platform indicates that how intelligent unman vehicle interfaces with cloud-based AI test platform. The AI test service platforms support and test on simulations based on diverse test resources, framework, and solutions using 4d AI unman vehicle test models and test data solutions. Inside of could-based AI test platform, there are 3 core parts to support system.
a. An intelligent car test engine (2401): it supports scalable car test instances, and each instance provides necessary AI test services and resources for each on-road under-test car. this engine will use 4d AI car test models, and related intelligent test data and solutions from the test platform.
b. An intelligent car test simulation (2402): it supports scalable car test simulations based on diverse test resources, framework, and solutions using 4d AI car test models, and test/training data solutions.
c. An intelligent car test service manager (2403): it supports scalable intelligent car test service projects in management, test resources, test data and script automations, and monitoring and billing.

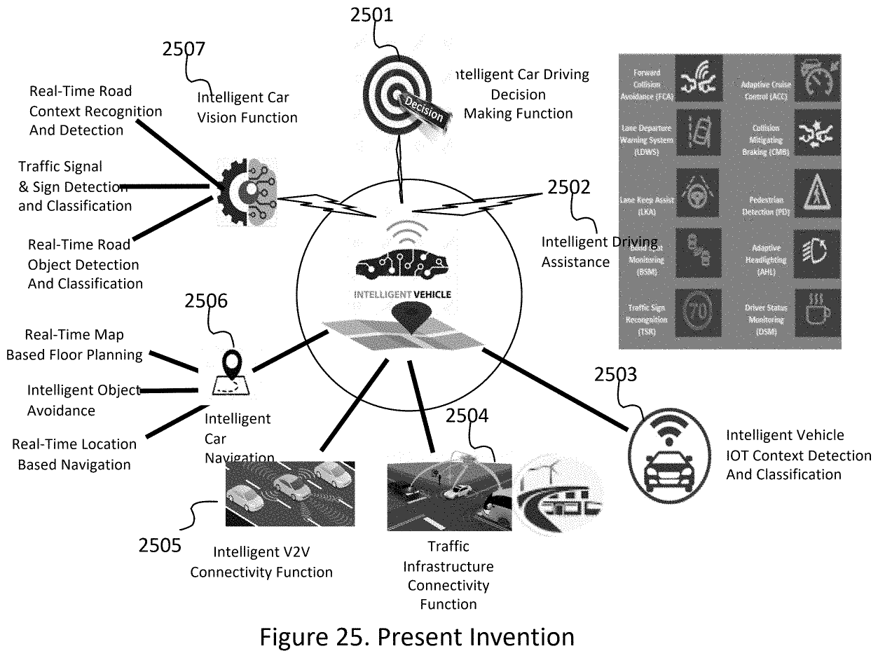

FIG. 25 illustrates that a testing scope of general intelligent car. a general intelligent car has intelligent car vision function (2507), intelligent car navigation (2506), intelligent v2v connectivity function (2504), traffic infrastructure connectivity function (2504), intelligent vehicle IOT context detection and classification (2503), intelligent driving assistance (2502), and intelligent car driving decision making function (2501). the cloud-based intelligent unman vehicle test platform testes all of those complements based on timeline and demonstrate the quality and service for each part.

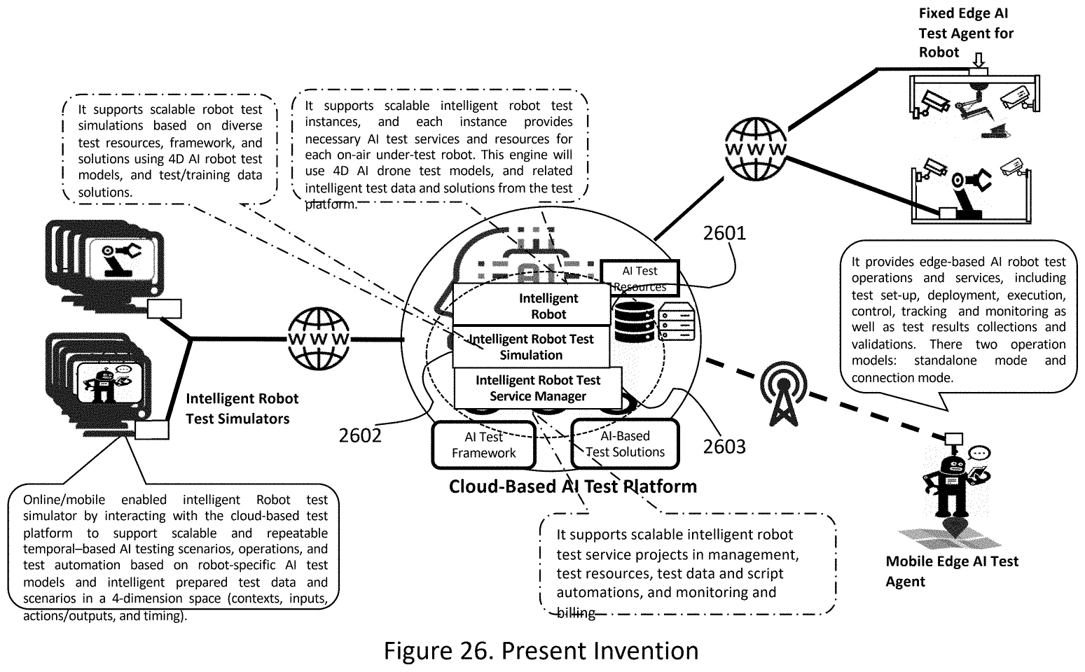

FIG. 26 illustrates that a cloud-based intelligent robot test platform indicates that how intelligent robot interfaces with cloud-based AI test platform. The AI test service platforms support and test on simulations based on diverse test resources, framework, and solutions using 4d AI robot test models and test data solutions. Inside of could-based AI test platform, there are 3 core parts to support system.
a. An intelligent robot system (2601): it supports scalable intelligent medical test instances, and each instance provides necessary AI test services and resources for each edge-based intelligent test system. this engine will use 4d AI medical test models, and related intelligent test data and solutions from the test platform.
b. An intelligent robot test simulation (2602): it supports scalable intelligent medical test simulations based on diverse test resources, framework, and solutions using 4d AI medical test models, and test/training data solutions.
c. An intelligent robot test service manager (2603): it supports scalable intelligent medical test service projects in management, test resources, test data and script automations, and monitoring and billing

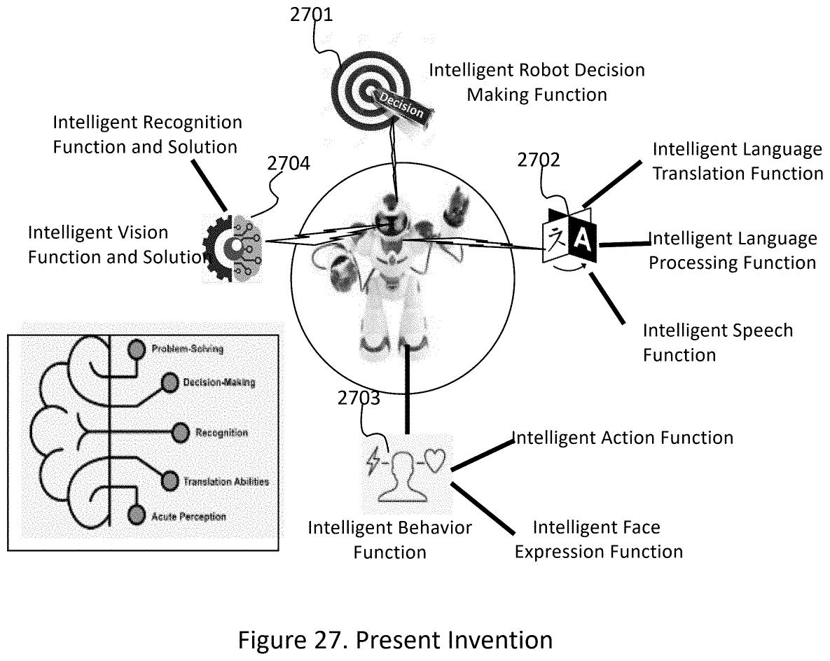

FIG. 27 illustrates that a testing scope of general intelligent robot. a general intelligent robot has intelligent recognition function and solution, intelligent vision function and solution (2704), intelligent behavior function (2703), intelligent language function (2702), and intelligent robot decision making function (2701). the cloud-based intelligent robot test platform testes all of those complements and demonstrate the quality and service for each part.

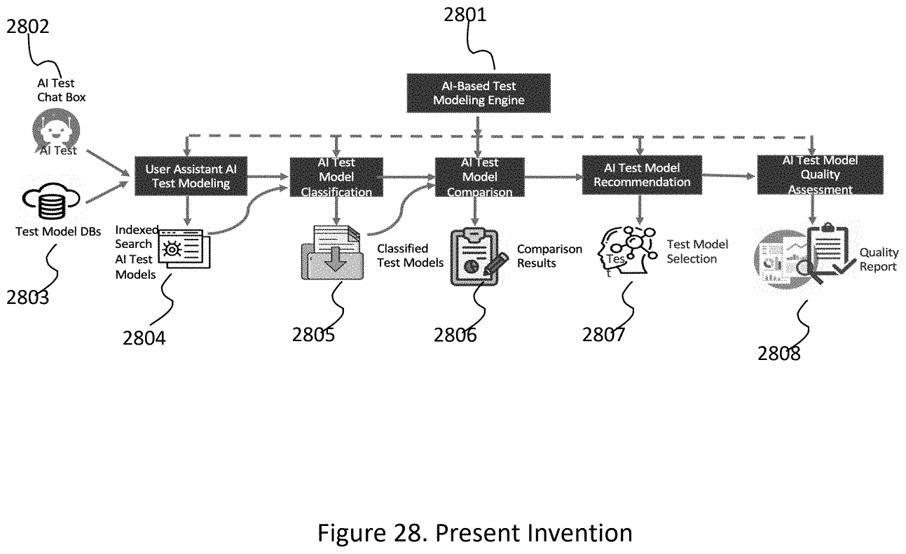

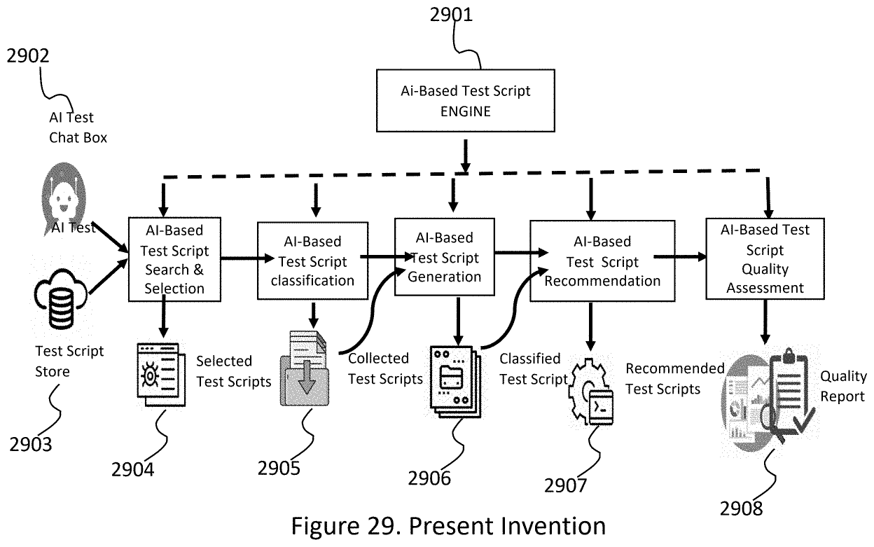

FIG. 28 is a flow diagram of the AI-based test modeling engine process (2801): from AI test chat box (2802) and test model DBs (2803), users search test models in test model databases (user assisted AI test modeling (2804)), then AI-based test modeling engine (2801) automatically starts to classify user-selected models (AI test model classification (2805)) and compares all those models to generate the result of selected models (AI test model comparison (2806)) and recommends the best model for users (AI test model recommendation (2807)), then demonstrates the quality assessment for AI test model (AI test quality assessment (2808)).

FIG. 29 is a flow diagram of the AI-based test scripting engine process (2901): from AI test chat box (2902) and test script store (2903), AI-based test script engine (2901) searches and makes selection for test scripts based on the model (AI-based test script search & selection (2904)) from AI-based test modeling engine, and classifies and collect all test scripts (AI-based test script classification (2905)), then generates all classified test scripts (AI-based test script generation (2906)) in order to find the most effective test script based on AI-based test script recommendation (2907), then demonstrates the quality report of test scripts (AI-based test quality assessment (2908)).

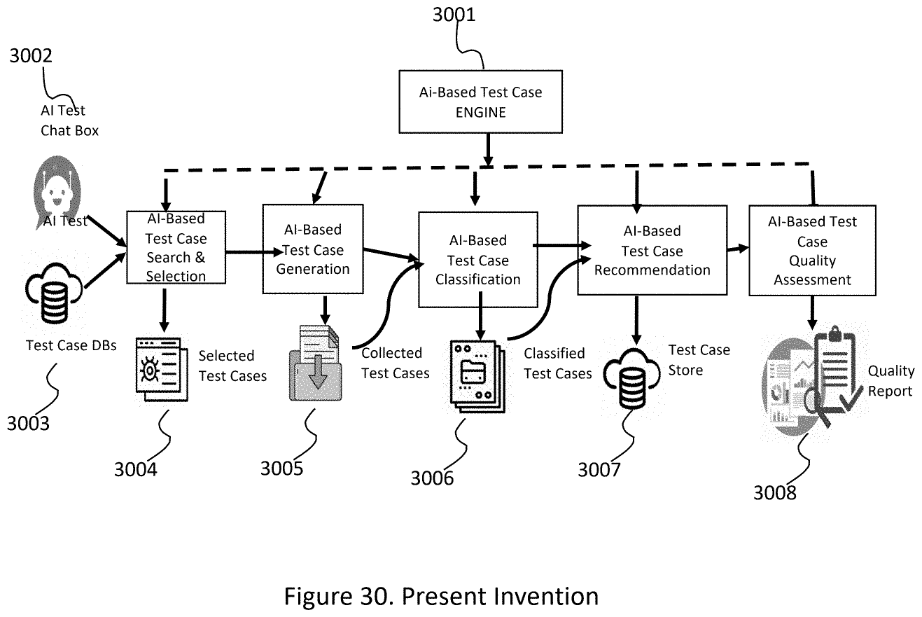

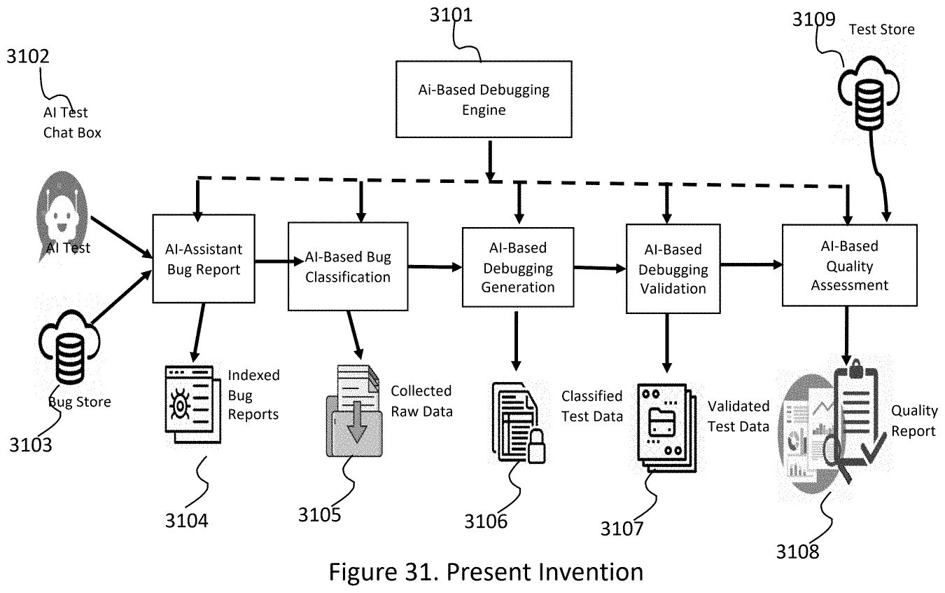

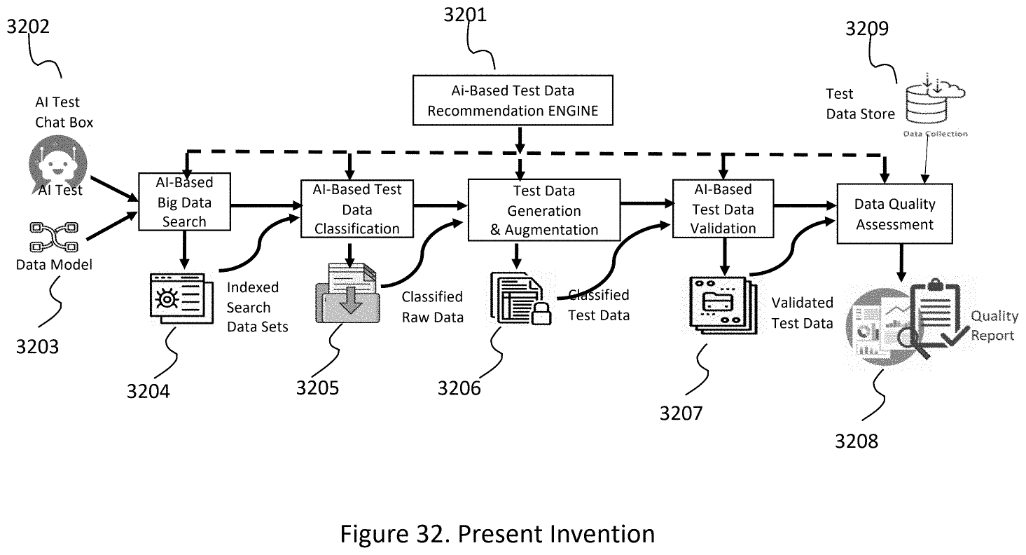

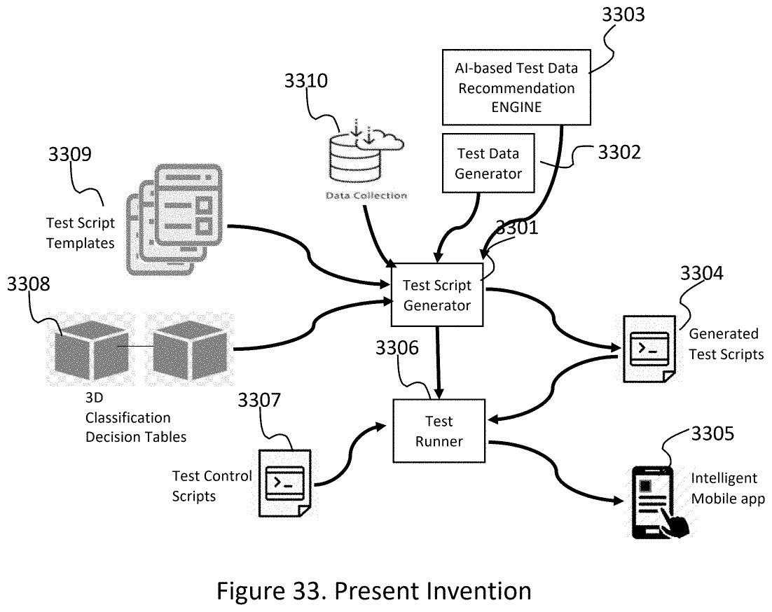

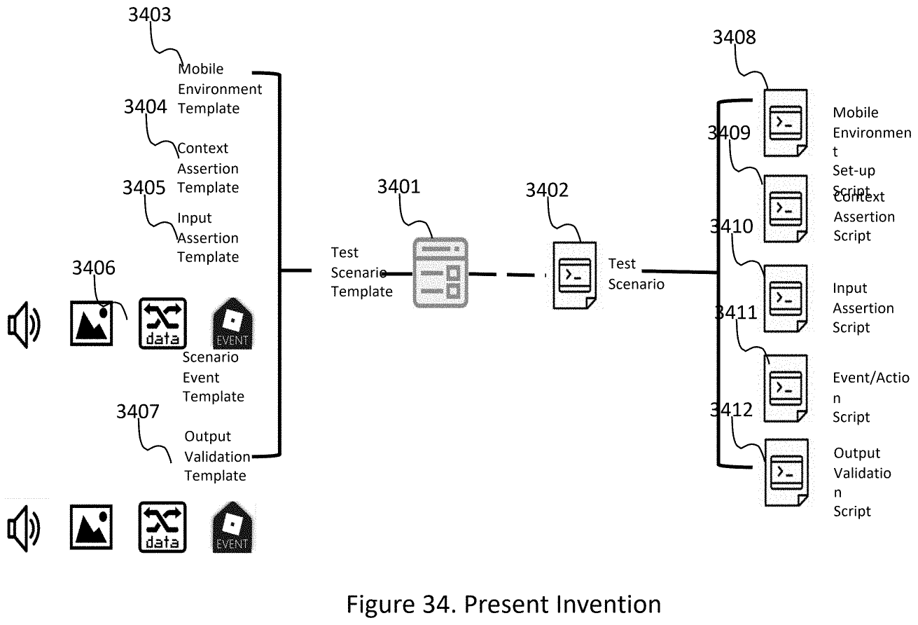

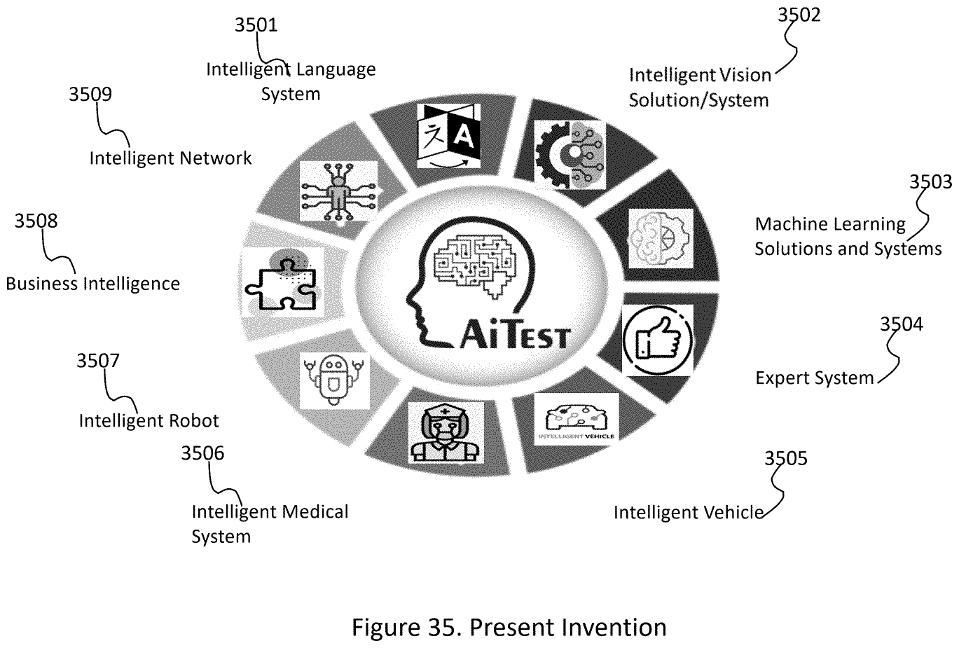

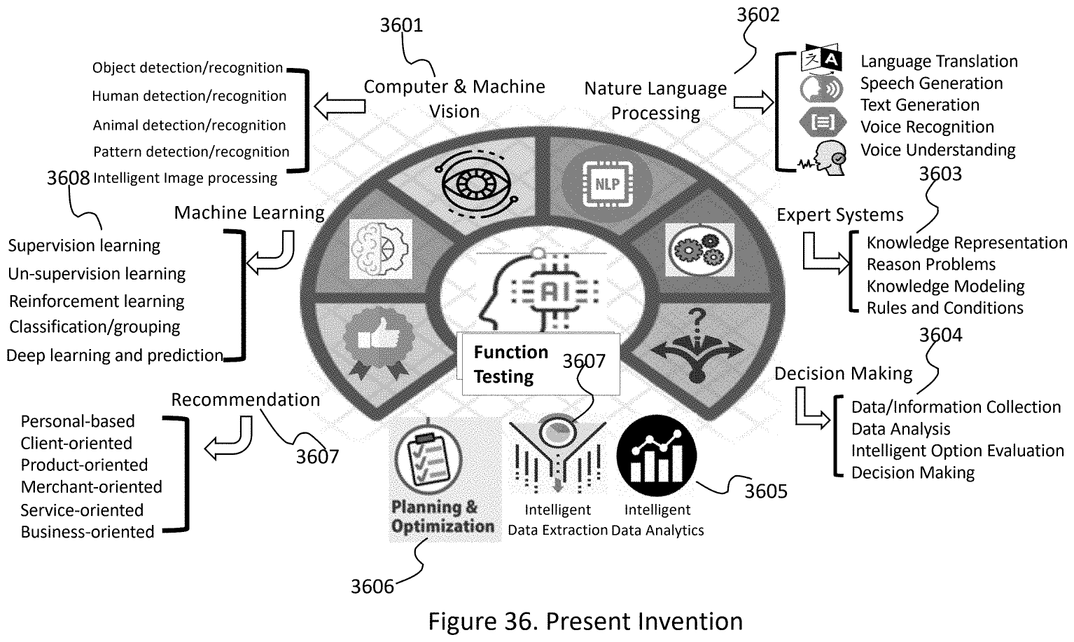

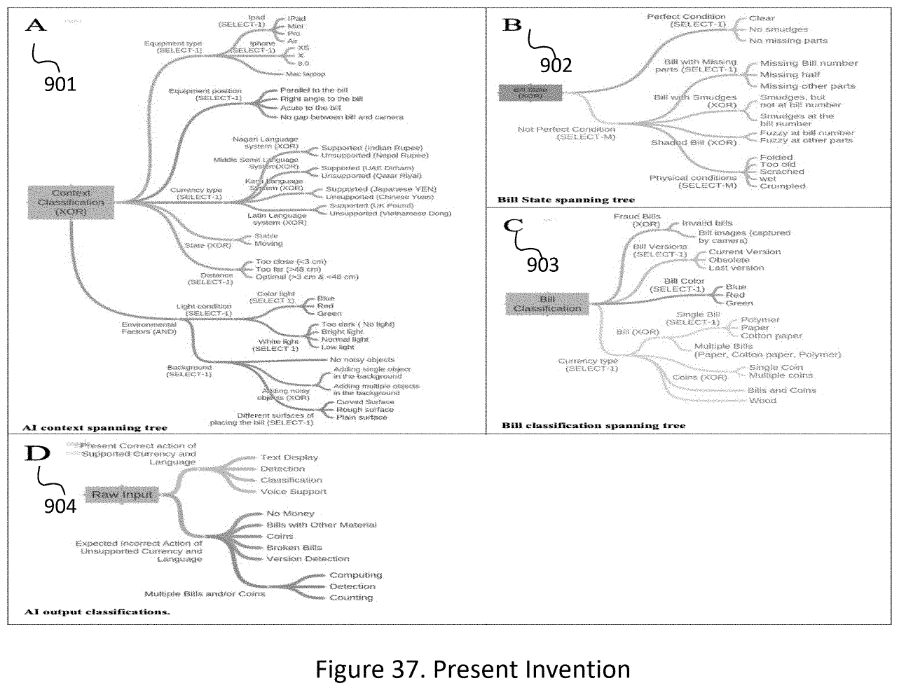

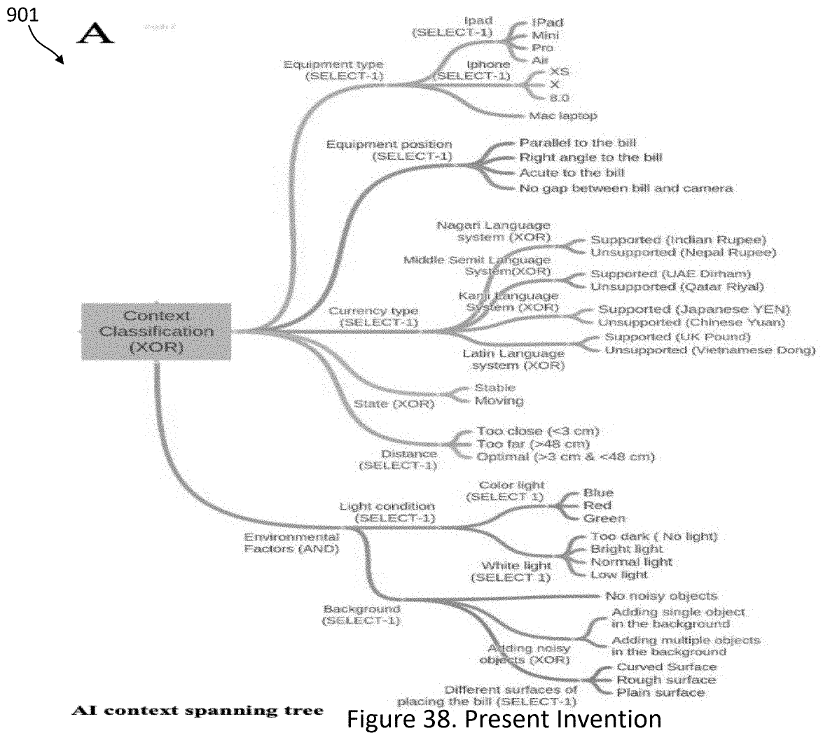

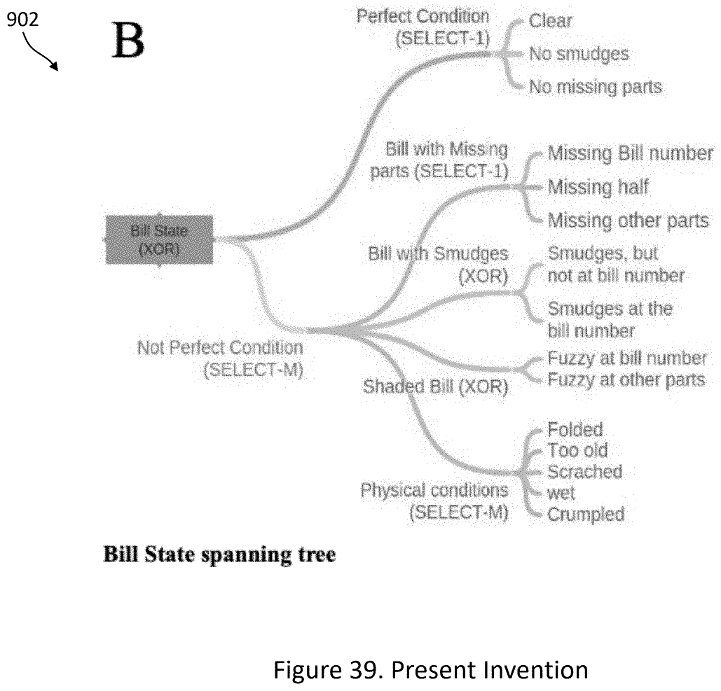

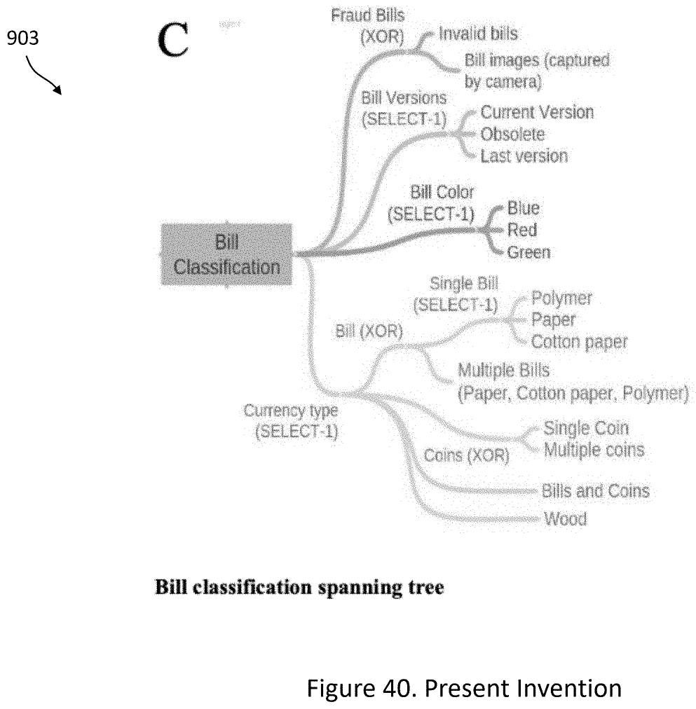

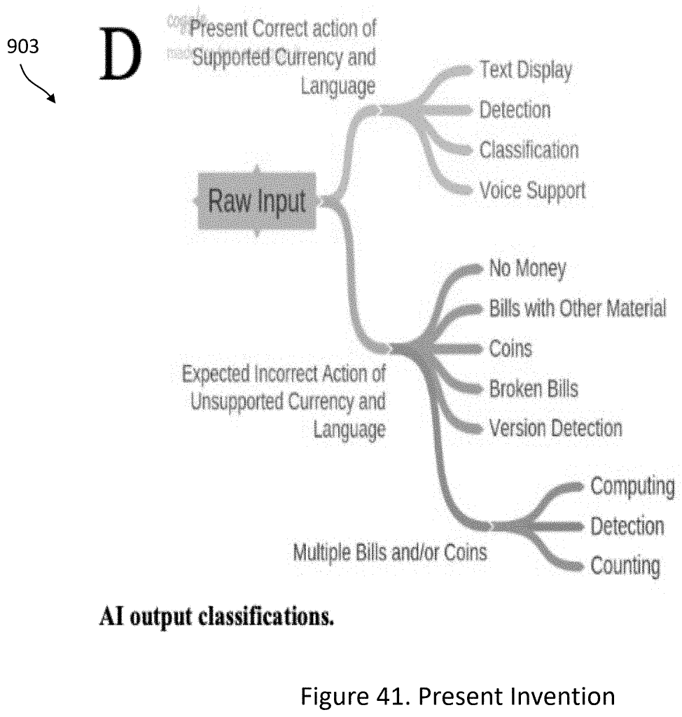

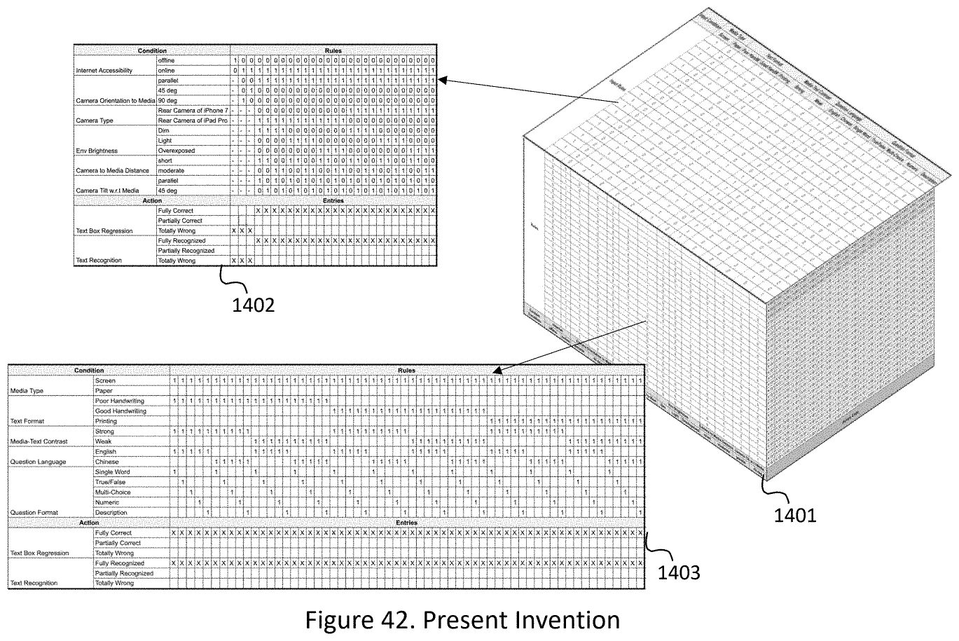

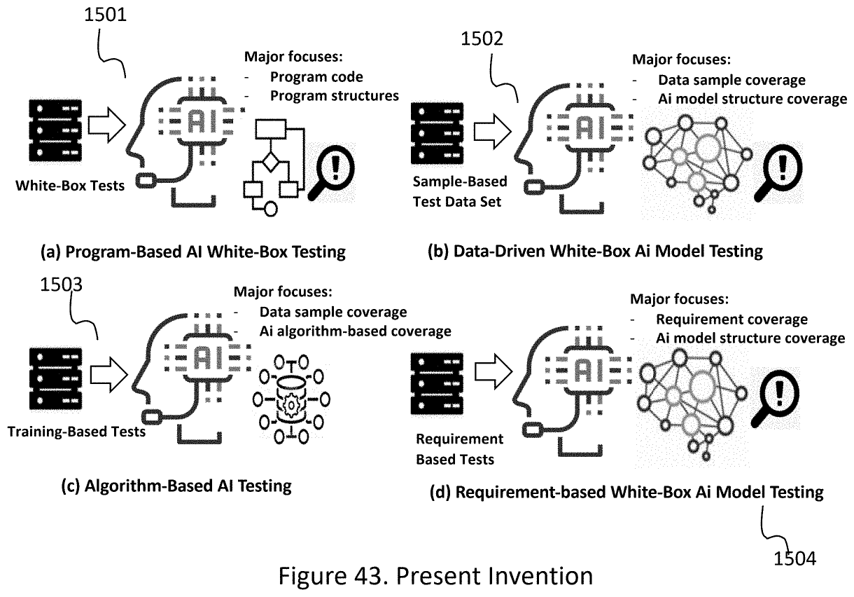

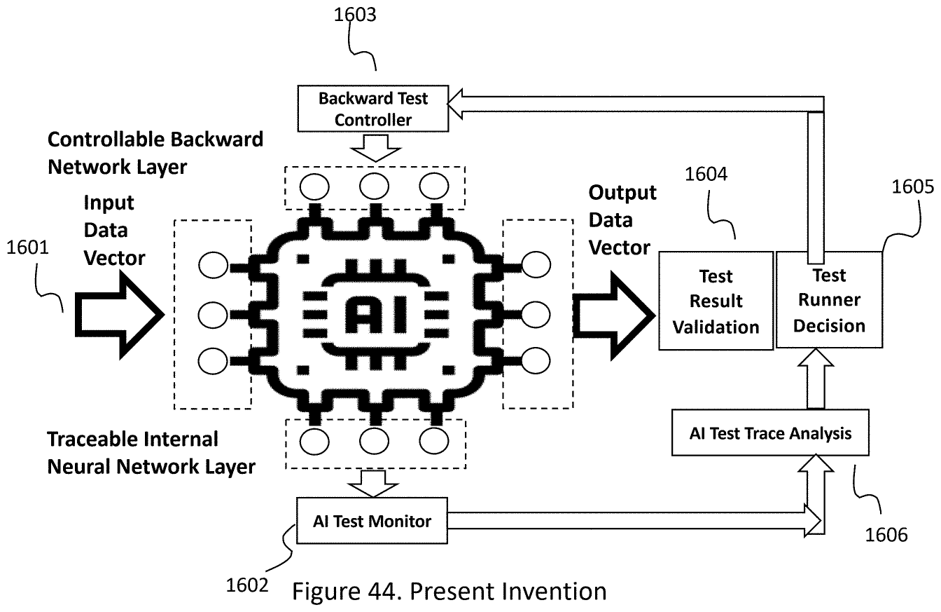

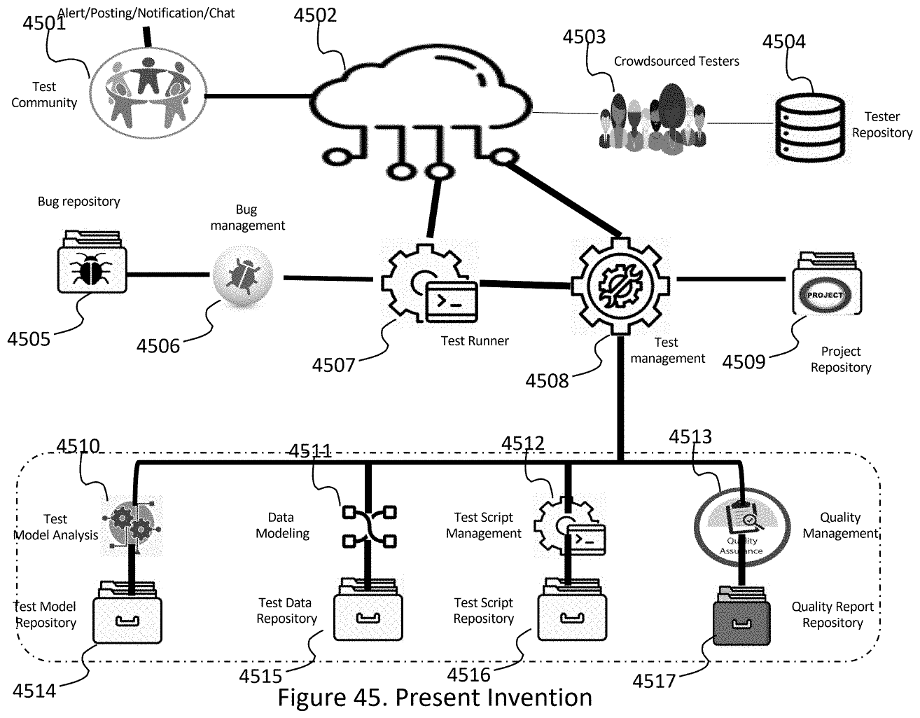

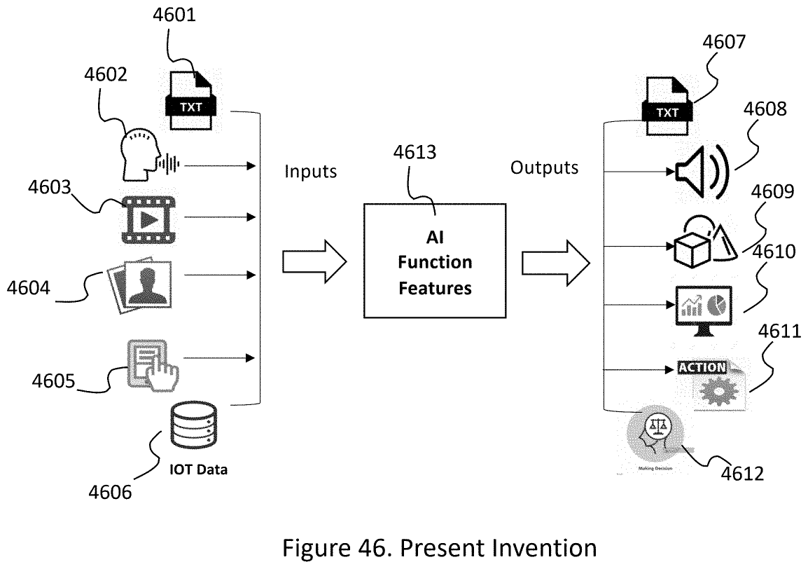

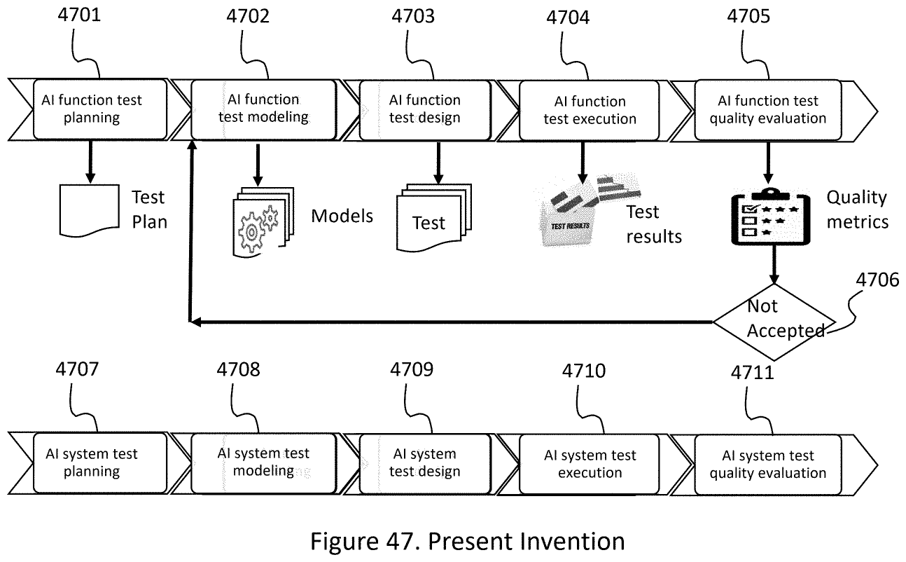

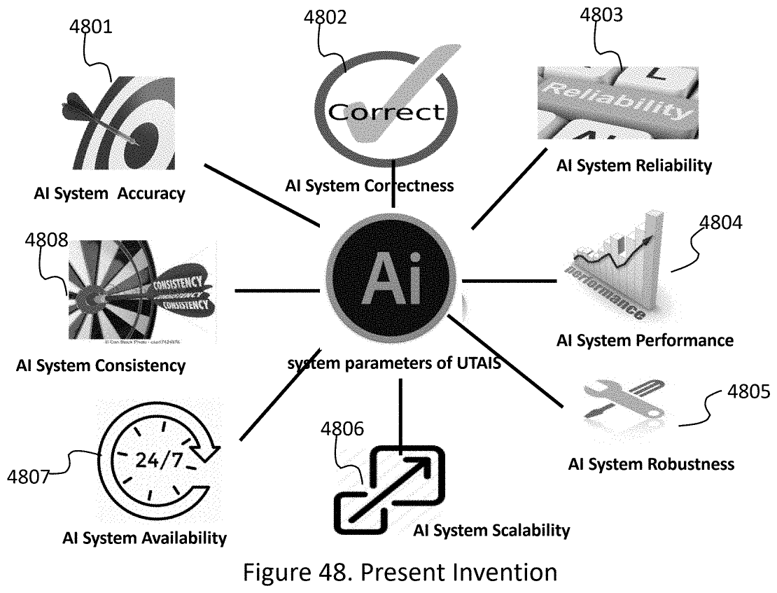

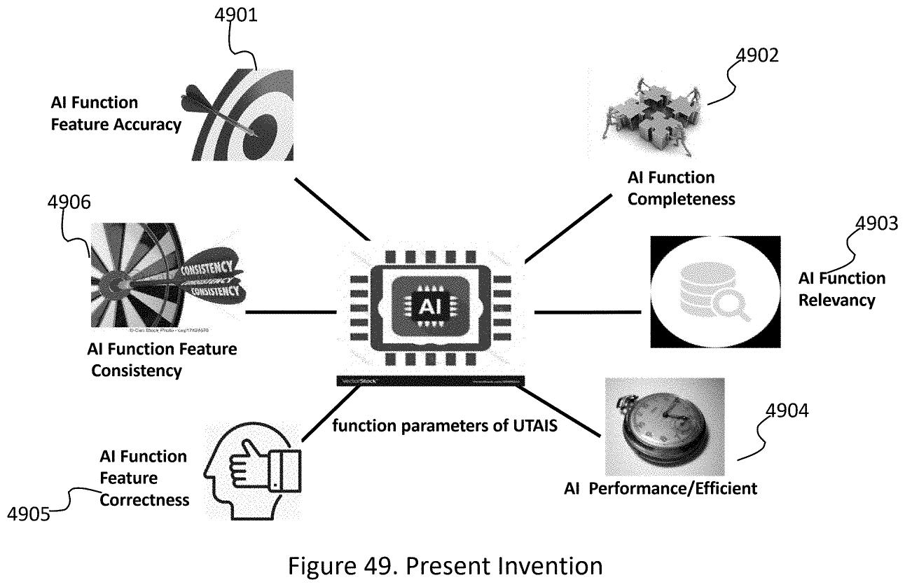

FIG. 30 is a flow diagram of the AI-based test case engine process (3001): from AI test chat box (3002) and test case DBs (3003), AI-based test case engine (3001) automatically searches test cases (AI-based test case search & selection (3004)) and collects all effectively test cases depended on test cases history and model (AI-based test case generation (3005)), then classifies all test cases (AI-based test case classification (3006)) and stores recommended test cases into test case DBs as future reference (AI-based test case recommendation (3007)), finally demonstrates the quality report for all test cases (AI-based test case quality assessment (3008)).

FIG. 31 is a flow diagram of the AI-based debugging engine process (3101): from AI test chat box (3102) and test case DBs (3103), AI-based debugging engine (3101) creates an AI-assistant bug report according to model and bug history (AI-assistant bug report (3104)), classifies bug and collect raw data (AI-based bug classification (3105)), then generates and validates test data on current model (AI-based debugging generation (3106) & AI-based debugging validation (3107)), demonstrates the debugging quality report (AI-based quality assessment (3108)) at the end of AI-based debugging engine (3101).

FIG. 32 is a flow diagram of the AI-based test data recommendation engine process (3201): from AI test chat box (3202) and test case DBs (3203), AI-based test data recommendation engine (3201) finds data sets by AI-based big data search (3204), then classifies raw data (AI-based test data classification (3205)), generates test data (test data generation & augmentation (3206)), and validates all test data (AI-based test data validation (3207)), finally, generates the quality report based on test data score (data quality assessment (3208)).

FIG. 33 is a flow diagram of a process of running test script for AI application. test script generator (3301) creates a few of generated test scripts (3304) with multi-dimension classification decision tables (3308) (test script templates contains running environment, etc.), raw data from data collections, test data from test data generator (3301) and AI-based test data recommendation engine (3303). then when test runner (3306) is activated, it automatically tests AI applications with generated test scripts (3304) and test control scripts (3307).

FIG. 34 is a flow diagram of a process of generating test scenario (3402).

FIG. 35 is a block diagram of a testing scope of AI software/system. The STAIS automatically testes all software/systems with AI, including intelligent language system (3501), intelligent vision solution/system (3502), machine learning solution and systems (3503), expert system (3504), intelligent vehicle (3505), intelligent medical system (3506), intelligent robot (3507), business intelligence (3508), and intelligent network (3509).

FIG. 36 is a block diagram of a testing scope of AI functions and feature. The STAIS automatically tests all AI functions in AI software/system, including
1. Computer & Machine Vision (3601): Object detection/recognition, Human detection/recognition, Animal detection/recognition, Pattern detection/recognition, and Intelligent Image/recognition.
2. Nature Language Processing (3602): Language Translation, Speech Generation, Text Generation, Voice Recognition, and Voice Understanding
3. Expert Systems (3603): Knowledge Representation, Reason Problems, Knowledge Modeling, and Rules and Conditions.
4. Decision Making (3604): Data/Information Collection, Data Analysis, Intelligent Option Evaluation, and Decision Making.
5. Machine Learning (3608): Supervision Learning, Un-supervision Learning, Reinforcement learning, Classification/Grouping, and Deep Learning and Prediction
6. Recommendation System (3607): Personal-based, Client-oriented, Product-oriented, Merchant-oriented, Service-oriented, and Business-oriented
7. Planning & Optimization (3606)
8. Intelligent Data Extraction (3607)
9. Intelligent Data Analytics (3605)

FIG. 9 is a block of tree diagrams of spanning trees from an AI application (bill reader). The STAIS automatically creates a multi-dimension decision table based on the AI context spanning tree (901), state spanning tree (902), and classification spanning tree (903), then generates the result spanning tree—AI output classification spanning tree (904). (Black-Box Testing)

FIG. 10 is a tree diagram of a context classification of spanning tree (901), its leaves automatically generate based on the context of UTAIS.

FIG. 11 is a tree diagram of a bill state spanning tree (902), its leaves automatically generate based on the context of UTAIS.

FIG. 12 is a tree diagram of a bill classification spanning tree (903), its leaves automatically generate based on the context of UTAIS.

FIG. 13 is a tree diagram of an output of spanning tree (904), its leaves automatically generate based on the context of UTAIS.

FIG. 14 is a block diagram of a multi-dimension decision table (1401) from UTAIS (word reader). Top surface has the same information of the context spanning tree (1402), and front surface has the classification spanning tree and the state spanning tree (1403), the right surface is the AI output classification spanning tree and all decisions on the AI output classification spanning tree is determined by different combination of the context spanning tree (901), the state spanning tree (902), and the classification spanning tree (903). The number of dimensions depends on the amount of conditions and context. (Black-Box Testing)

FIG. 15 is a block diagram of white-box testing for the STAIS includes four testing ways to test UTAIS under white-box testing.
A. A program-based AI white-box testing process (1501): this part of testing majorly focuses on program code and program structures for testing AI-based application.
B. A data-driven white-box AI model testing process (1502): this part of testing majorly focuses on data sample coverage and AI model structure coverage for testing AI-based application.
C. An algorithm-based AI testing process (1503): this part of testing majorly focuses on data sample coverage and AI algorithm-based coverage for testing AI-based application.
D. A requirement-based white-box AI model testing process (1504): this part of testing majorly focuses on requirement coverage and AI model structure coverage for testing AI-based application.

FIG. 16 is a flow diagram of a process of white-box testing for AI applications. first, the STAIS automatically inputs all raw data vector into traceable internal neural network layer (1601). during the process of testing, an AI test trace analysis (1606) generates and displays from AI test monitor (1602). at the same time, output data will be generated and validate with expected output data. finally, test runner determines whether test result is validated or not based on test result validation (1604) and AI test trace analysis (1606). if the output data vector does not pass the test runner decision (1605), it will re-test through backward test controller (1603) until the output data passes test runner decision (1605).

FIG. 45 is a flow diagram of a general process of AI-test service platform. after test runner (4507) is active, test management (4508) automatically connects testing AI application with test model analysis (4510), test data modeling (4511), test script management (4512), and quality management (4513) on the AI test service platform. at the same time, during the time of debugging, detect and save bugs into bug repository as future reference. all test cases, data, and model come from crowdsourced testers (4503) and test community (4501) through AI test cloud (4502).

FIG. 46 is a flow diagram of the expected output of AI feature test (4613). In the unit of AI functions feature (4613), the STAIS automatically transfers and store input data to become the data that STAIS understands. For example, transferring documents to e-documents that can be stored and read in computer (4601 & 4607), transfer human-speaking to audio that can be played in computer (4602 & 4608), transfer movies to pictures (4603 & 4609), transfer pictures to graphs with descriptions (4604 & 4610), transfer human-motion to action (4605 & 4611), and transfer IDT date to decision what human can easily understand (4606 & 4612).

FIG. 47 is a flow diagram of a process of AI Function/Software quality validation is the general steps of quality validation.
1. AI function test planning creates test plan for testing software (4701 & 4707).
2. AI function test modeling generates the model for testing software (4702 & 4708).
3. AI function test design creates to design test cases based on model and test data (4703 & 4709).
4. AI function test execution starts to test and map for expected outputs based on model and test cases from previous steps (4704 & 4710).
5. AI function test quality evaluation compares the expected outputs and actual output. If the quality of actual outputs is not satisfied, then re-processes from AI function test modeling until system accepts (4705 & 4711 &4706).

FIG. 48 illustrates that system parameters for UTAIS tested by STAIS. The quality of UTAIS is depended on AI system accuracy (4801), AI system correctness (4802), AI system reliability (4803), AI system performance (4804), AI system robustness (4805), AI system scalability (4806), AI system availability (4807), and AI system consistency (4808).

FIG. 49 illustrates that function parameters for UTAIS tested by STAIS. In the AI systems, AI function feature accuracy (4901) focuses on the accuracy of system, AI function feature consistency (4906) focuses on the consistency of system, AI function feature correctness (4905) focuses on the correctness of system, AI function completeness (4902) checks the completeness of AI system, AI function relevancy (4903) checks the relevancy between system and application, and AI performance/efficient (4904) checks the performance/efficient of AI system.

1. A System for testing an artificial intelligence (AI) System(s) (STAIS), wherein the artificial intelligence system(s), to be tested, is/are herein distinctively and specifically described as an Under-test artificial intelligence System(s) (UTAIS), comprises
a. an AI test framework;
b. an AI test platform;
c. an AI test resource library; and
d. an AI test solution.

2. The system of claim 1 wherein the AI test framework comprises
a. a program supporting and performing AI test analysis and modeling;
b. a program supporting and performing AI test quality evaluation;
c. a set of AI test connectors and interfaces; and
d. a program generating AI test scripts.

3. The system of claim 1 wherein the AI test platform comprises
a. a sub-platform for testing medical/healthcare application specific UTAIS;
b. a sub-platform for testing robotics application specific UTAIS;
c. a sub-platform for testing mobile application specific UTAIS;
d. a sub-platform for testing unmanned vehicle/drone application specific UTAIS; and
e. a sub-platform for testing business application specific UTAIS.

4. The system of claim 1 wherein the AI test resource library comprises
a. a sub-library of classified background media including classified background images, videos, and audios;
b. a sub-library of classified object media including classified object images, videos, and audios;
c. a sub-library of classified texts and strings;
d. a sub-library of classified data augmentation; and
e. a sub-library of classified data models.

5. The system of claim 1 wherein the AI test solution comprises
a. one or more AI-based test modeling engine(s)/program(s) using AI techniques for discovering existing AI function test models and assisting derivation of new AI function test models;
b. one or more AI-based test scripting engine(s)/program(s) using AI techniques for assisting new script derivation;
c. one or more AI-based test case engine(s)/program(s) using AI techniques for selecting test cases;
d. one or more AI-based debugging engine(s)/program(s) using AI techniques for detecting bugs and analyzing detected bugs; and
e. one or more AI-based test data recommendation engine(s)/program(s) using AI techniques for recommending test data.

6. The system of claim 2 wherein the program supporting and performing AI test analysis and modeling comprises
a. a sub-program for AI requirement analysis modeling;
b. a sub-program for AI function test modeling;
c. a sub-program for multi-dimension (mD) classification;
d. a sub-program for white-box AI test modeling; and
e. a sub-program for test data modeling.

7. The system of claim 2 wherein the program generating AI test scripts comprises
a. an AI test generator supporting multi-dimension (mD) test generation;
b. an AI test specific scripting language as an extension of existing test script language;
c. an AI test scripting program supporting test script generation; and
d. an AI test runner supporting auto test execution, control, and monitoring.

8. The system of claim 2 wherein the set of AI test connectors or interfaces comprises
a. a set of AI test connectors or interfaces supporting test automation and service for AI-powered medical applications, i.e., medical application specific artificial intelligence system(s);
b. a set of AI test connectors or interfaces supporting test automation and service for AI-powered robotics applications, i.e., robotics application specific artificial intelligence system(s);
c. a set of AI test connectors or interfaces supporting test automation and service for AI-powered unmanned vehicle applications, i.e., unmanned vehicle application specific artificial intelligence system(s);
d. a set of AI test connectors or interfaces supporting test automation and service for AI-powered business applications, i.e., business application specific artificial intelligence system(s); and
e. a set of AI test connectors or interfaces supporting test automation and service for AI-powered mobile applications, i.e., mobile application specific artificial intelligence system(s).

9. The system of claim 2 wherein the program performing AI test quality evaluation comprises
a. a sub-program supporting an AI function quality assessment;
b. a sub-program supporting an AI system quality assessment;
c. a sub-program having requirement-based AI test coverages;
d. a sub-program supporting model-based AI test coverage analyses;
e. a sub-program supporting AI function test complexity analyses; and
f. a sub-program supporting AI system test complexity analyses.

10. The system of claim 3 wherein the sub-platform for testing medical/healthcare application specific UTAIS comprises
a. an intelligent medical system test simulator interfaceable with medical/healthcare application specific UTAIS; and
b. an intelligent medical system test service manager interfaceable with the intelligent medical system test simulator and the medical/healthcare application specific UTAIS.

11. The system of claim 3 wherein the sub-platform for testing robotics application specific UTAIS comprises
a. an intelligent robot test simulator interfaceable with robotics application specific UTAIS; and
b. an intelligent robot test service manager interfaceable with the intelligent robot test simulator and the robotics application specific UTAIS.

12. The system of claim 3 wherein the sub-platform for mobile application specific UTAIS comprises
a. an intelligent mobile system test simulator interfaceable with mobile application specific UTAIS; and
b. an intelligent mobile system test service manager interfaceable with the intelligent mobile system test simulator and the mobile application specific UTAIS.

13. The system of claim 3 wherein the sub-platform for unmanned vehicle applications specific UTAIS comprises
a. an intelligent unmanned vehicle/drone test simulator interfaceable with unmanned vehicle application specific UTAIS; and
b. an intelligent unmanned vehicle/drone test service manager-with the intelligent unmanned vehicle/drone test simulator and the unmanned vehicle application specific UTAIS.

14. The system of claim 3 wherein the sub-platform for business application specific UTAIS comprises
a. an intelligent business system test simulator interfaceable with business application specific UTAIS; and
b. an intelligent business system test service manager interfaced with the intelligent business system test simulator and the business application specific UTAIS.

15. The system of claim 5 wherein the AI-based test modeling engine(s)/program(s) using AI techniques for discovering AI function test models comprises
a. a user assisted AI test modeling program(s);
b. an AI-based test model classification program(s);
c. an AI-based test model comparison program(s);
d. an AI-based test model recommendation program(s); and
e. an AI-based test model quality assessment program(s).

16. The system of claim 5 wherein the set of AI-based test scripting engine(s)/program(s) using AI techniques for generating scripts comprises
a. an AI-based test script search and selection;
b. an AI-based test script classification;
c. an AI-based test script generation;
d. an AI-based test script recommendation; and
e. an AI-based test script quality assessment.

17. The system of claim 5 wherein the AI-based test case engine/program using AI techniques for selecting test cases comprises
a. an AI-based test case search and selection;
b. an AI-based test case classification;
c. an AI-based test case generation;
d. an AI-based test case recommendation; and
e. an AI-based test case quality assessment.

18. The system of claim 5 wherein the AI-based debugging engine/program using AI techniques for detecting bugs and analyzing detected bugs comprises
a. an AI-based bug report;
b. an AI-based bug classification;
c. an AI-based debugging generation;
d. an AI-based debugging validation; and
e. an AI-based debugging quality assessment.

19. The system of claim 5 wherein the AI-based test data recommendation engine/program using AI techniques for recommending test data comprises
a. an AI-based big data search;
b. an AI-based test data classification;
c. an AI-based data generation and augmentation;
d. an AI-based test data validation; and
e. an AI-based test data quality assessment.

20. A method for testing an artificial intelligence system(s), wherein the artificial intelligence system(s) is/are herein distinctively and specifically described as under-test artificial intelligence system(s) (UTAIS), comprises
a. having an AI test framework;
b. having an AI test platform;
c. having an AI test resource library; and
d. having an AI test solution(s).

21. The method of claim 20 wherein having an AI test framework comprises
a. having a program performing AI test analysis and modeling;
b. having a program performing AI test quality evaluation;
c. having a set of AI test connectors and interfaces; and
d. having a program generating AI test scripts.

22. The method of claim 20 wherein having an AI test platform comprises
a. having a sub-platform for testing a medical/healthcare application specific UTAIS;
b. having a sub-platform for testing a robotics application specific UTAIS;
c. having a sub-platform for testing a mobile application specific UTAIS;
d. having a sub-platform for testing an unmanned vehicle application specific UTAIS; and
e. having a sub-platform for testing a business application specific UTAIS.

23. The method of claim 20 wherein having an AI test resource library comprises
a. having a sub-library of classified background media including images, videos, and audios;
b. having a sub-library of classified object media including images, videos, and audios;
c. having a sub-library of classified texts and strings;
d. having a sub-library of classified data augmentation; and
e. having a sub-library of classified data models.

24. The method of claim 20 wherein having an AI test solution(s) comprises
a. having an AI-based test modeling engine/program using AI techniques for discovering AI function test models;
b. having an AI-based test scripting engine/program using AI techniques for generating scripts;
c. having an AI-based test case engine/program using AI techniques for selecting test cases;
d. having an AI-based debugging engine/program using AI techniques for detecting bugs and analyzing detected bugs; and
e. having an AI-based test data recommendation engine/program using AI techniques for recommending test data.

25. The method of claim 21 wherein having a program performing AI test analysis and modeling comprises
a. having a sub-program for AI requirement analysis modeling;
b. having a sub-program for AI function test modeling;
c. having a sub-program having a multi-dimensional (mD) classification;
d. having a sub-program for white-box AI test modeling; and
e. having a sub-program for test data modeling.

26. The method of claim 21 wherein having a program generating AI test scripts comprises
a. having an AI test generator;
b. having an AI test language;
c. having an AI test scripting program; and
d. having an AI test runner.

27. The system of claim 21 wherein having a set of AI test connectors or interfaces comprises
a. having a set of AI test connectors or interfaces supporting test automation and service for AI-powered medical applications, i.e., medical application specific artificial intelligence system(s);
b. having a set of AI test connectors or interfaces supporting test automation and service for AI-powered robotics applications, i.e., robotics application specific artificial intelligence system(s);
c. having a set of AI test connectors or interfaces supporting test automation and service for AI-powered unmanned vehicle applications, i.e., unmanned vehicle application specific artificial intelligence system(s);
d. having a set of AI test connectors or interfaces supporting test automation and service for AI-powered business applications, i.e., business application specific artificial intelligence system(s); and
e. having a set of AI test connectors or interfaces supporting test automation and service for AI-powered mobile applications, i.e., mobile application specific artificial intelligence system(s).

28. The method of claim 21 wherein having a program performing AI test quality evaluation comprises
a. having a sub-program for an AI function quality assessment;
b. having a sub-program for an AI system quality assessment;
c. having a sub-program having requirement-based AI test coverages;
d. having a sub-program for model-based AI test coverage analyses;
e. having a sub-program for AI function test complexity analyses; and
f. having a sub-program for AI system test complexity analyses.

29. The system of claim 22 wherein having a sub-platform for testing medical/healthcare application specific UTAIS comprises
a. having an intelligent medical system test simulator interfaceable with medical/healthcare application specific UTAIS and
b. having an intelligent medical system test service manager interfaceable with the intelligent medical system test simulator and the medical/healthcare application specific UTAIS.

30. The system of claim 22 wherein having a sub-platform for testing robotics application specific UTAIS comprises
a. having an intelligent robot test simulator interfaceable with robotics application specific UTAIS; and
b. having an intelligent robot test service manager interfaceable with the intelligent robot test simulator and the robotics application specific UTAIS.

31. The system of claim 22 wherein having a sub-platform for mobile application specific UTAIS comprises
a. having an intelligent mobile system test simulator interfaceable with mobile application specific UTAIS; and
b. having an intelligent mobile system test service manager interfaceable with the intelligent mobile system test simulator and the mobile application specific UTAIS.

32. The system of claim 22 wherein having a sub-platform for unmanned vehicle application specific UTAIS comprises
a. having an intelligent unmanned vehicle/drone test simulator interfaceable with unmanned vehicle application specific UTAIS; and
b. having an intelligent unmanned vehicle/drone test service manager interfaceable with the intelligent unmanned vehicle/drone test simulator and the unmanned vehicle application specific UTAIS.

33. The system of claim 22 wherein having a sub-platform for business applications specific UTAIS comprises
a. having an intelligent business system test simulator interfaceable with business application specific UTAIS; and
b. having an intelligent business system test service manager interfaced with the intelligent business system test simulator and the business application specific UTAIS.

34. The method of claim 24 wherein having an AI-based test modeling engine/program using AI techniques for discovering AI function test models comprises
a. having a user assisted AI test modeling;
b. having an AI-based test model classification;
c. having an AI-based test model comparison;
d. having an AI-based test model recommendation; and
e. having an AI-based test model quality assessment.

35. The method of claim 24 wherein having an AI-based test scripting engine/program using AI techniques for generating scripts comprises
a. having an AI-based test script search and selection;
b. having an AI-based test script classification;
c. having an AI-based test script generation;
d. having an AI-based test script recommendation; and
e. having an AI-based test script quality assessment.

36. The method of claim 24 wherein having an AI-based test case engine/program using AI techniques for selecting test cases comprises
a. having an AI-based test case search and selection;
b. having an AI-based test case classification;
c. having an AI-based test case generation;
d. having an AI-based test case recommendation; and
e. having an AI-based test case quality assessment.

37. The method of claim 24 wherein having an AI-based debugging engine/program using AI techniques for detecting bugs and analyzing detected bugs comprises
a. having an AI-based bug report;
b. having an AI-based bug classification;
c. having an AI-based debugging generation;
d. having an AI-based debugging validation; and
e. having an AI-based debugging quality assessment.

38. The method of claim 24 wherein having an AI-based test data recommendation engine/program using AI techniques for recommending test data comprises
a. having an AI-based big data search;
b. having an AI-based test data classification;
c. having an AI-based data generation and augmentation;
d. having an AI-based test data validation; and
e. having an AI-based test data quality assessment.
